(19) United States
(12) Patent Application Publication
(10) Pub. No.: US 2026/0118669 A1
(43) Pub. Date: Apr. 30, 2026

(54) IMPROVED COLOR UNIFORMITY IN DISPLAYS HAVING LIGHTGUIDE OPTICAL ELEMENTS

(71) Applicant: LUMUS LTD., Ness Ziona (IL)

(72) Inventors: Tsion EISENFELD, Ashkelon (IL); Elad SHARLIN, Mishmar David (IL)

(21) Appl. No.: 19/484,071

(22) PCT Filed: Jul. 5, 2024
(86) PCT No.: PCT/IL2024/050655

§ 371 Date: Nov. 13, 2025

Related U.S. Application Data
(60) Provisional application No. 63/524,942, filed on Jul. 5, 2023.
(60) Provisional application No. 63/603,724, filed on Nov. 29, 2023.

(51) Int. Cl. G02B 27/01; G03B 21/20

(52) U.S. Cl. CPC G02B 27/0101; G03B 21/2013; G02B 2027/0112

(57) ABSTRACT

A display (100) includes a lightguide optical element (102) with internal partially reflecting surfaces (106) for delivering an image from an image projector (100) to the eye of a viewer. Chromatic variations in the appearance of white pixels across the output image are reduced by using a broad-spectrum white light source (114W) to provide at least part of the illumination for the white pixels. Additionally, or alternatively, chromatic corrections for groups of white pixels, or for individual pixels, are provided by delivering corresponding white-balance corrective illumination from red, blue and/or green light sources (114R, 114G, 114B). The corrections are derived from maps of chromatic variations for the display when activated to deliver a uniform white image as calculated, or preferably measured, at one or more locations within an eye-motion box (108) from which the image is to be viewed.

### FIELD AND BACKGROUND OF THE INVENTION

The present invention relates to displays, in particular displays having micro image projectors that generate collimated image illumination for injection into a lightguide optical element (LOE) with reflective or partially reflective couplers.

Optical arrangements used in a near eye display (NED) or a head up display (HUD), for example as part of augmented reality (AR) or virtual reality (VR) applications, require a large aperture to cover the area where the eye of the observer is located (referred to as the eye motion box, or EMB). Certain optical arrangement technologies, such as those of Lumus Ltd., employ a lightguide optical element (LOE), also referred to as a “light-transmitting substrate” or simply “substrate”, having a series of internal mutually parallel partially reflective surfaces that are inclined obliquely to major external surfaces of the LOE. A micro image projector that is optically coupled to the LOE generates illumination corresponding to a collimated image, and the collimated image illumination is injected into the LOE by an optical coupling-in arrangement (for example a reflective surface or a coupling prism) so as to propagate through the LOE by internal reflection (in many cases, total internal reflection or TIR) at the major external surfaces of the LOE. The propagating image is progressively coupled out of the LOE toward the viewer's eye by reflection at the series of partially reflective surfaces, thereby expanding the effective optical aperture of the image at the EMB.

Reflectivity of the partially reflective surfaces (as well as of coupling-in reflectors) is sensitive to various parameters of the incident illumination, including the spectral range of the illumination, polarization state, and angle of incidence. The partially reflective surfaces are typically coated with optical coatings to generate a desired reflectivity pattern as a function of incident angle and are intended to have similar reflective properties for different wavelengths of illumination across the entire visible spectrum.

The micro image projector can be implemented in various ways, including implementations that employ back-lit and front-lit architectures. In one example, the image projector employs illumination sources (typically a set of colored light sources such as LEDs or lasers, e.g., red (R), green (G), blue (B) LEDs or lasers), a spatial light modulator such as a liquid crystal on silicon (LCOS) chip that applies spatial light modulation to the LED illumination, and collimating optics that collimates the modulated illumination, typically all arranged on surfaces of one or more polarization selective beamsplitter (PBS) cube or other prism arrangement. The image projector operates as a color sequential imaging device (CSD), alternatively referred to as field sequential color (FSC), whereby primary color information (e.g., R, G, B) is transmitted to the optical coupling-in arrangement in successive images at high frame rates, and the human visual perception combines the primary color images (coupled-out by the partially reflective surfaces) into a single perceived picture of true color. Typically, when generating images with non-white pixels, or images with white pixels that do not require high accuracy or uniformity of white color, the image projector components can produce uniform color images from the primary colors (e.g., R, G, B) that are of high quality. In order to produce white pixels in images of white objects or a white uniform background, the intensities of the primary colors can be adjusted as required. However, issues may arise with the ability of the optical coatings of the partially reflective surfaces to render, with fidelity, white pixels across the image. Specifically, since the performance of the optical coatings are dependent both on angle and on wavelength, the coating reflectance and transmittance of the primary colors (e.g., R, G, B) vary in different ways across the image. It is possible to balance the intensities of the RGB sources in order to obtain a perfect white for a single pixel in the image. But this balance for a single pixel will lead to variation in the white tone for other pixels in the image because the white color for those other pixels is obtained with the same RGB source balance but with different coating performances. These white tonal variations across the pixels in the image may be noticeable to the viewer, which can reduce the quality of the viewer's viewing experience.

### SUMMARY OF THE INVENTION

The present invention is a display for presenting an image to the eye of a user.

According to the teachings of an embodiment of the present invention there is provided, a display for presenting an image to an eye of a user, the display comprising: (a) a lightguide optical element (LOE) having a pair of mutually parallel major surfaces for supporting propagation of light corresponding to an image by internal reflection at the major surfaces, the LOE including a set of mutually parallel partially reflecting coupling-out surfaces, internal to the LOE and angled obliquely to the major surfaces, for coupling out the light corresponding to the image towards the eye of the user; and (b) an image projector optically coupled to the LOE for introducing light corresponding to the image into the LOE so as to propagate within the LOE, the image projector including light sources of at least four distinct spectral properties including a red light source, a green light source, a blue light source and a white light source, and a controller configured to actuate the image projector to generate the light corresponding to the image, wherein the controller is configured to operate in at least a first mode in which at least part of an intensity of at least a subset of pixels of the image is generated by the white light source.

According to a further feature of an embodiment of the present invention, the subset of pixels is the subset of pixels of the image set to white.

According to a further feature of an embodiment of the present invention, the image projector further comprises a spatial light modulator (SLM), and wherein, in the first mode, the controller actuates the light sources to sequentially illuminate the SLM with pulses of light from the red, green and blue light sources and with a pulse generated at least in part by the white light source.

According to a further feature of an embodiment of the present invention, a first group of at least one white pixel is illuminated by the white light source plus a first white-balance corrective illumination from the red light source, the green light source and/or the blue light source, and wherein a second group of at least one white pixel is illuminated by the white light source plus a second white-balance corrective illumination from the red light source, the green light source and/or the blue light source, the second white-balance corrective illumination being different from the first white-balance corrective illumination.

According to a further feature of an embodiment of the present invention, the white pulse together with the first white-balance corrective illumination is delivered as a first white pulse illuminating the SLM and the white pulse together with the second white-balance corrective illumination is delivered as a second white pulse illuminating the SLM.

According to a further feature of an embodiment of the present invention, the first white-balance corrective illumination and the second white-balance corrective illumination are generated by setting pixels of the SLM to corresponding brightness values during illumination pulses from the red, green and blue illumination sources.

According to a further feature of an embodiment of the present invention, a composition of the first white-balance corrective illumination and a composition of the second white-balance corrective illumination are derived from a calibration map of chromatic aberration introduced by the LOE for white light reaching an eye motion box from which the image is to be viewed.

According to a further feature of an embodiment of the present invention, a composition of the first white-balance corrective illumination and a composition of the second white-balance corrective illumination are derived as a function of eye position from calibration maps of chromatic aberration introduced by the LOE for white light reaching multiple locations within an eye motion box from which the image is to be viewed.

According to a further feature of an embodiment of the present invention, each group of pixels is a single pixel and each pixel has its own composition of white-balance corrective illumination.

According to a further feature of an embodiment of the present invention, the controller is further configured to operate in a second mode in which the controller actuates the light sources to sequentially illuminate the SLM with pulses of light from the red, green and blue light sources and the white light source is not activated, and wherein the controller switches between the second mode and the first mode according to a non-uniformity visibility criterion.

According to a further feature of an embodiment of the present invention, the white light source includes a white LED having a blue spectral peak at a first wavelength, and wherein the blue light source has a spectral peak at a second wavelength that is longer than the first wavelength.

According to a further feature of an embodiment of the present invention, the white light source includes a white LED having a blue spectral peak at a wavelength between 460 and 490 nm.

According to a further feature of an embodiment of the present invention, the white light source includes a white LED having a color temperature between 3500 K and 4500 K, and wherein the controller is configured to actuate the white light source together with the blue light source to generate illumination with a color temperature of at least 6000 K.

There is also provided according to the teachings of an embodiment of the present invention, a display for presenting an image to an eye of a user, the display comprising: (a) a lightguide optical element (LOE) having a pair of mutually parallel major surfaces for supporting propagation of light corresponding to an image by internal reflection at the major surfaces, the LOE including a set of mutually parallel partially reflecting coupling-out surfaces, internal to the LOE and angled obliquely to the major surfaces, for coupling out the light corresponding to the image towards the eye of the user; and (b) an image projector optically coupled to the LOE for introducing light corresponding to the image into the LOE so as to propagate within the LOE, the image projector including light sources of at least three distinct spectral properties including a red light source, a green light source and a blue light source, and a controller configured to actuate the image projector to generate the light corresponding to the image, wherein the controller is configured to operate in at least a first mode in which the controller: (i) receives pixel image data corresponding to an image to be displayed; (ii) identifies within the pixel data a subset of pixels that are set to a uniform white; (iii) generates modified pixel data in which data for at least the subset of pixels are modified to correct for chromatic aberration introduced by the LOE; and (iv) actuates the image projector to generate the image according to the modified pixel data.

According to a further feature of an embodiment of the present invention, the modified pixel data are generated based on a calibration map of chromatic aberration introduced by the LOE for white light reaching an eye motion box from which the display is to be viewed.

According to a further feature of an embodiment of the present invention, the modified pixel data are generated as a function of eye position from calibration maps of chromatic aberration introduced by the LOE for white light reaching multiple locations within an eye motion box from which the display is to be viewed.

According to a further feature of an embodiment of the present invention, the image projector includes a plurality of scanned laser sources.

According to a further feature of an embodiment of the present invention, the image projector further comprises a spatial light modulator (SLM), and wherein, in the first mode, the controller actuates the light sources to sequentially illuminate the SLM with pulses of light from the red, green and blue light sources and with a pulse of white light.

According to a further feature of an embodiment of the present invention, the pulse of white light is generated by simultaneous operation of the red, green and blue light sources.

According to a further feature of an embodiment of the present invention, the pulse of white light is generated at least in part by a white light source.

According to a further feature of an embodiment of the present invention, two different groups within the subset of pixels are illuminated by two distinct pulses of white light including, respectively, a first white-balance corrective illumination and a second white-balance corrective illumination.

According to a further feature of an embodiment of the present invention, all of the subset of pixels are illuminated by a common pulse of white light, and wherein white-balance corrective illumination for each of the pixels in the subset of pixels is generated by setting pixels of the SLM to corresponding brightness values during illumination pulses from the red, green and blue illumination sources.

### BRIEF DESCRIPTION OF THE DRAWINGS

The invention is herein described, by way of example only, with reference to the accompanying drawings, wherein:

FIG. 1 is a plot of the relative luminous intensity spectrum of a set of commercially available blue, green and red LEDs;

FIG. 2 is a plot of the relative luminous intensity spectrum of a commercially available white LED;

FIG. 3A is a plot of the relative luminous intensity spectrum of an alternative white LED;

FIG. 3B shows two color offset maps for pixels of a white image illuminated in a display device of the present invention by the white LED of FIG. 3A at two locations in an eye-motion box;

FIG. 4A is a plot of the relative luminous intensity spectrum of a further alternative white light source created from a superposition of LED sources;

FIG. 4B shows five color offset maps for pixels of a white image illuminated in a display device of the present invention by the white light source of FIG. 4A at five locations in the eye-motion box;

FIG. 5A is a plot of the relative luminous intensity spectrum of an alternative white light source generated by combining three separate color LEDs;

FIG. 5B shows two color offset maps for pixels of a white image illuminated in a display device of the present invention by the white light source of FIG. 5A at two locations in an eye-motion box;

FIG. 6A is a block diagram of a display device, constructed and operative according to an embodiment of the present invention, for displaying an image to the eye of a viewer;

FIG. 6B is a block diagram illustrating a system for mapping the chromatic aberration of the display device of FIG. 6A;

FIG. 7A is a diagram of an eye-motion box of the system of FIG. 6A illustrating 5 reference locations from which a displayed image may be viewed;

FIG. 7B shows five color offset maps for pixels of a white image as measured by the system of FIG. 6B at locations 1-5 of FIG. 7A when illuminated by RGB LEDs with spectral properties as in FIG. 1;

FIG. 7C shows five color offset maps for pixels of a white image as measured by the system of FIG. 6B at locations 1-5 of FIG. 7A when illuminated by a white LED with spectral properties as in FIG. 2;

FIG. 8 is a schematic representation of a four-pulse illumination scheme in which each frame of an image is illuminated by pulses of red, green, blue and white illumination;

FIG. 9 illustrates schematically a first arrangement for introducing light from four sources into an image projector using a light pipe;

FIG. 10 illustrates schematically a second arrangement for introducing light from four sources into an image projector using dichroic and polarizing beam combiners;

FIGS. 11 and 12 illustrate schematically two further arrangements for introducing light from four sources into an image projector using a polarizing beam splitter;

FIG. 13A is an image of an output from the display of FIG. 6A when actuated to generate a white image when illuminated by RGB LEDs with spectral properties as in FIG. 1;

FIG. 13B is a scatter plot illustrating the distribution of color offset values for pixels of the image of FIG. 13A;

FIG. 14A is a map showing classification of pixels from FIG. 13A into three subgroups according to a direction of the color offset;

FIG. 14B is a version of the scatter plot of FIG. 13B in which the points are color-classified to correspond to the subgroups of FIG. 14A;

FIG. 15A is a color offset map illustrating the color offset of the output image after implementation of color offset compensation according to an aspect of the present invention;

FIG. 15B is similar to the scatter plot of FIG. 14B shown after correction of the color offset;

FIG. 16A is a schematic representation of an illumination sequence which includes three single-color pulses and three modified white pulses;

FIG. 16B is a scatter plot of color offset for white pixels in a displayed image mapping three groups of pixels to be illuminated by the three modified white pulses of FIG. 16A, respectively;

FIGS. 17A and 17B are color offset maps for a white image illuminated by RGB pulses and by modified white pulses, respectively;

FIGS. 18A and 18B are color offset histograms for pixels of the images of FIGS. 17A and 17B, respectively;

FIG. 19A is a view similar to FIG. 16A for an implementation using a white light source with an illumination spectrum according to FIG. 2 as part of the illumination of white pixels, but with each modified white pulse having additional RGB color components;

FIG. 19B is a scatter plot of color offset for white pixels in a displayed image when illuminated by the white light source mapping three groups of pixels to be illuminated by the three modified white pulses of FIG. 19A, respectively;

FIG. 20A-22B are views equivalent to FIGS. 13A-15B, respectively, where the unmodified white illumination is from a white light source with spectral properties as shown in FIG. 2;

FIGS. 23A-24B are views equivalent to FIGS. 17A-18B, respectively, where the unmodified white illumination is from a white light source with spectral properties as shown in FIG. 2;

FIG. 25A is a schematic representation of an illumination scheme with three pulses of modified white illumination for three groups of pixels (equivalent to FIG. 16A) while FIGS. 25B and 25C illustrate how an equivalent pixel response can be achieved, for non-white pixels and for white pixels, respectively, using only four pulses;

FIGS. 26A-26C are equivalent to FIGS. 25A-25C, respectively, where part of the white pulse(s) is provided by a white light source with spectral properties as shown in FIG. 2;

FIG. 27 is a table showing a partial list of commercially available LED types with the corresponding peak wavelengths;

FIG. 28 is a schematic illustration of an illumination source which combines two triads of RGB LEDs having different peak wavelengths so as to provide illumination properties better mimicking a continuous wavelength source for white illumination;

FIGS. 29A and 29B show normalized emission spectra for the first and second triads of LEDs from FIG. 28;

FIGS. 30A and 30B show the emission spectra for the same first and second triads of LEDs after each triad has been white balanced; and

FIG. 30C shows a combined output spectrum achieved by superposition of the white balanced spectra of FIGS. 30A and 30B.

### DESCRIPTION OF THE PREFERRED EMBODIMENTS

The present invention provides various features and corresponding methods for enhancing the perceived uniformity of white pixels in a display, and particularly a display that employs a lightguide optical element with internal partially reflecting surfaces. According to a first aspect of the present invention, certain embodiments of the present invention provide a micro image projector that includes a white light source, for example a white LED, that is used in combination with the primary color light sources (e.g., RGB LEDs or lasers) whenever an image that requires accuracy for white pixels (for example images of white objects or white uniform background) is required. The image projector operates to illuminate the requisite accurate white color by combining the light produced by the white light source (LED) together with the light produced by the primary color light sources (RGB LEDs or lasers). Different white tones can be obtained with different RGB and white intensity combinations. An advantage of the embodiments of the present invention is that adding the RGB spectra to the white spectrum allows generation of a more continuous spectrum, which provides a direct improvement to white image color uniformity and white color rendering across the entire image.

According to an alternative aspect of the present invention, two or more sources of different peak wavelengths may be used for each of the RGB illumination channels, either combined simultaneously or temporally interspaced, providing an overall effect equivalent to broader spectrum illumination sources and thereby providing an improvement in white image color uniformity.

According to a further aspect of the present invention, variations in color tone generated by different pixels for a given eye position are mapped and are grouped into subsets with similar color tone offsets from white. Those subsets are illuminated by separate pulses of modified-white illumination which are adjusted in order to compensate for the average color tone offset of that subset. This second aspect of the present invention may be used with conventional RGB illumination sources or may be used in combination with RGB-White illumination according to the first aspect of the present invention, all as will be described further below.

According to a further aspect of the present invention, a single white pulse per frame may be used to deliver some or all of the components of white illumination common to all of the white pixels, and the required white-correction supplements may be delivered by appropriate setting of the pixel intensity value during the RGB pulses of the frame. This approach can be applied to groups of pixels, or to individual pixels, in the latter case achieving pixel-by-pixel white balance correction. Unlike conventional electronic white balance correction, the dynamic range of the display is not impacted by this approach, since the additional white pulse ensures coverage of the entire dynamic range.

### Overview

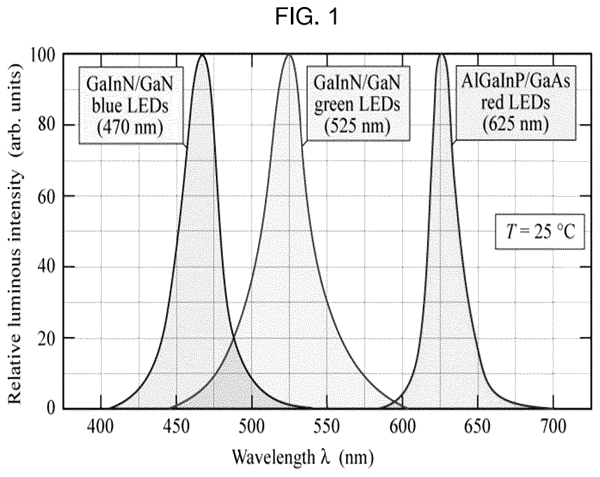

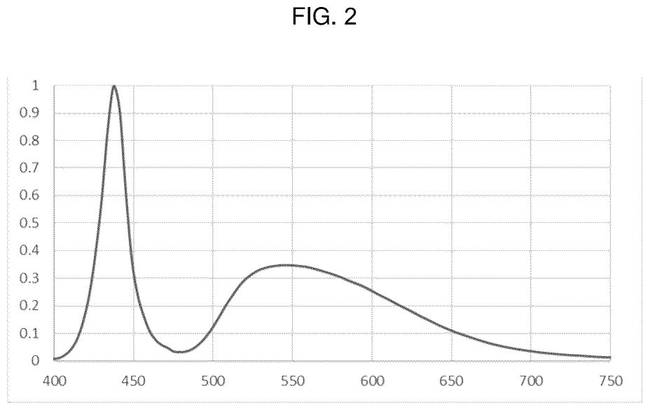

According to the first aspect of the present invention, a white light source is selected for use as part of the image projector illumination sources. The white light source can be selected from any number of different white light sources, each having different spectral distribution, but each being considered a shade of white. FIG. 2 shows the spectral distribution of an example white light source, implemented as a white LED. FIG. 1 shows the spectral distributions of the primary colors (R, G, B) and white light overlaid on a single graph.

The selection of the white light source can be based on which of the white light sources has optimal (or near optimal) performance with the optical coatings used to produce the partially reflective surfaces of the LOE. This may be determined empirically. In such a case, an image that is produced by the image projector using a white light source is coupled-out of the LOE by the partially reflective surfaces toward one or more optical sensor positioned at the EMB, and a processing subsystem evaluates the color difference of the output image at the EMB to determine optimality. This will be discussed in further detail below.

The design requirements on the partially reflecting surfaces used in an LOE can be challenging. The partially reflecting surfaces are implemented using multi-layer dielectric coatings which are ideally required to be partially reflecting for all colors of visible light. In some cases, the surfaces need to be partially reflecting within a first range of incident angles while being transparent for all colors of visible light within a second range of incident angles. This uniformity of properties across the visible spectrum is difficult to achieve, and there are inevitably variations as a function of wavelength. It has been found, however, that the variations tend to be exacerbated by using narrow-band RGB sources, and the broader the spectrum of the illumination source, the more the variations tend to average out and become less noticeable. Typical output spectra for RGB LED sources (using a super blue LED for reasons that are discussed further below) are shown in FIG. 1. Each peak is relatively narrow, with minimal overlap between green and red, and in many cases also between blue and green, depending on the choice of blue LED. An ideal illumination for generating uniform white pixels would be a continuous spectrum white source which extends across all, or almost all, of the visible spectrum. One further consideration is that the design requirements for the partially reflecting coatings may be significantly easier to meet if the conditions are relaxed for deep blue (shorter) wavelengths.

Practically, as seen in FIG. 2, commercially available white LEDs are typically made from a blue LED with one or more type of phosphor coating which absorbs part of the blue light and reemits “yellow” light of a relatively broad spectral range spanning green and red, thereby resulting in an overall white emission. The blue LED employed in the white LED often has a peak wavelength of around 450 nanometers, and may have a discontinuity in the emission spectrum around 480 nanometers, which falls between the blue peak and the phosphor emission spectrum. This emission spectrum is typically non-optimal, since the deep blue around 450 nm is handled less uniformly by the dielectric coatings than longer blue wavelengths, and the spectrum lacks the advantages of continuity mentioned above.

One approach to achieving a better-optimized white illumination for use in an LOE-based display is to supplement the output of a white LED that has a spectral gap with an additional LED which overlaps that gap, thereby achieving a more continuous output spectrum. In the above case of FIG. 2, this can be achieved by adding a “super blue” LED which has a peak wavelength of about 470 nm, thereby filling in the gap in the white LED spectrum and additionally ensuring that a major part of the blue illumination falls within the 460-490 nm range, which is more evenly handled by the dielectric coatings.

In order to avoid unbalancing the white illumination, it is advantageous to employ a white LED with a black body temperature equivalence that is lower than the target color temperature and then use the super blue LED to rebalance the color temperature to the desired temperature. In a typical example of a desired white color D65 (6500 K), it has been found advantageous to use a white LED with color temperature in the range 3500-4500 K, thereby having relatively weak deep blue and a strong yellow emission, and to supplement this with the super blue LED to return the color temperature to 6500 K. Additionally or alternatively, the desired color balance may be achieved by adding a combination of illumination from separate green and red LEDs to balance any excess contribution of the super blue LED.

This superposition of illumination from a white LED with a super blue LED may be achieved by combining two light sources into a compound white light source, distinct from the RGB LEDs or lasers used for the regular color display. Alternatively, the super blue LED (or any other LED chosen to fill in a spectral gap for a particular white LED) may be one of the illumination sources used for illuminating color pixels according to the normal RGB illumination scheme.

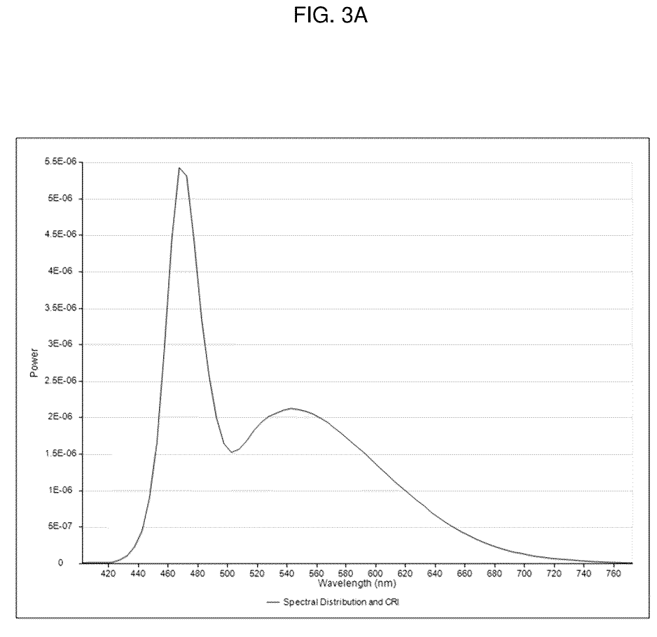

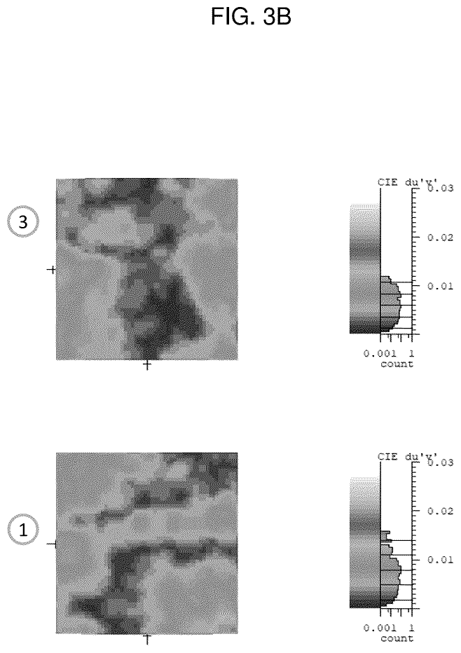

A further option which may be used to advantage is to select a white LED in which the blue LED component is itself a longer wavelength blue source with a peak wavelength in the 460-490 nm range, such as for example a super blue with a peak around 470 nm. This tends to avoid the spectral gap, as illustrated in FIG. 3A, and also inherently ensures that the blue illumination injected into the LOE is in the preferred longer-wavelength part of the spectrum.

Parenthetically, it will be appreciated that the above discussion is highly specific to displays using LOEs with partially reflecting coatings, where the use of a near-continuous spectrum for white illumination provides the aforementioned advantages of enhanced uniformity. This stands in clear contrast to displays based on diffractive optical elements, where each wavelength typically requires its own dedicated diffractive elements and substrate, and each light source should be spectrally narrow.

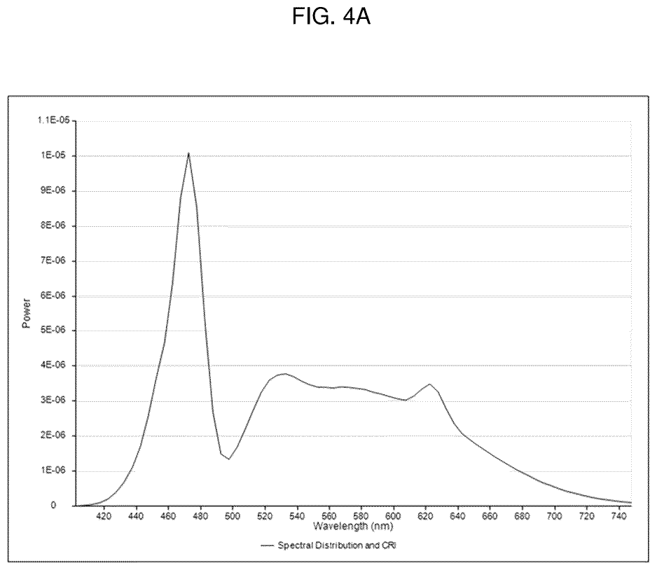

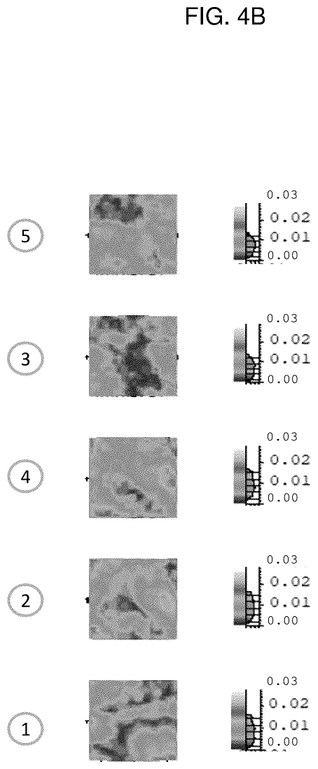

Regarding optimization of the white light source, a qualitative discussion is presented here, but the details of which of the available white sources is preferred, what additional sources should be used to balance the color temperature, and what coating design should be used are best derived by use of optical simulation software and/or computer models. To further illustrate the complexity of the variables, in each of the above examples, an off-the-shelf white LED may have a particular spectral distribution that is good but not optimal for the optical coating design, and a different white light with a different spectral distribution may be better suited for the coating design. For example, as mentioned, the spectral distribution of the white light in FIG. 2 has a dip at around 450 nm, which in essence creates a discontinuity in the spectral distribution at around 480 nm due to the weaker blue component in the white light. An alternative white light source produces white light having a spectral distribution as illustrated in FIG. 3A, which has a color temperature of around 8,000 K. If a white light source with such a preferred spectral distribution is not available, a white LED with weaker blue primary color in combination with an individual blue (e.g., super blue at around 470 nm) that compensates for the weak blue in the white light can be used. Simulations or computer modeling can be performed to generate such a synthesized white light. More preferably, the white light source produces white light that has a spectral distribution as illustrated in FIG. 4A. The white light illustrated in FIG. 4A has a temperature of around 6,500 K. In order to produce the white light illustrated in FIG. 4A, a white light source (e.g., a 4,000 K white LED) is used in combination with R and G light sources (adding red and green color components) as well as a B light source that produces super blue (around 470 nm) for white balancing. The lower white LED temperature allows to minimize the intensity and as a consequence the effect of the deep blue color peak (which is typically in a less convenient spectrum region, e.g., between around 440 nm to 450 nm).

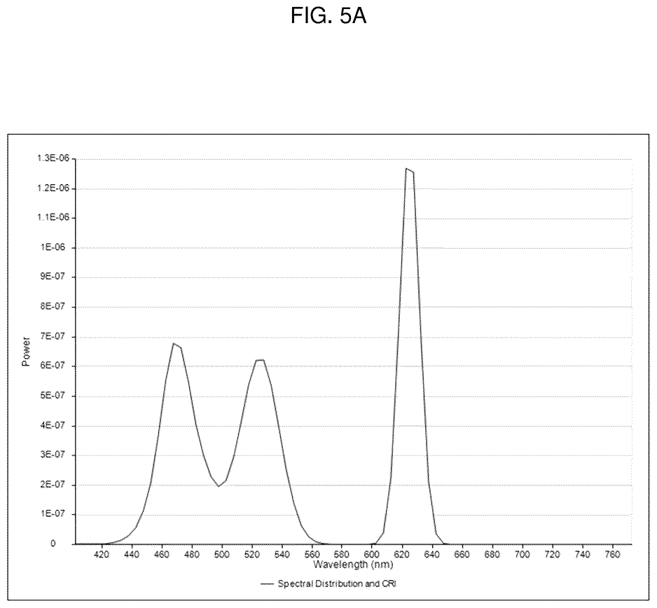

FIG. 5A shows the spectral distribution of white light generated by a triad of RGB LEDs where the blue is super blue with a peak wavelength of around 470 nm, similar to a combination of the LED spectra illustrated in FIG. 1. As a result of the relatively long wavelength of the blue source, there is significant overlap between the blue and the green LED outputs, providing continuity in that region. There is, however, a discontinuity at around 580 nm which makes this option less desirable as a white source. Here too, it may be possible to fill this gap by adding a supplementary LED, although in this case, the additional source would be a yellow spectrum which would need to be a dedicated addition unsuitable for using in the regular RGB illumination arrangement.

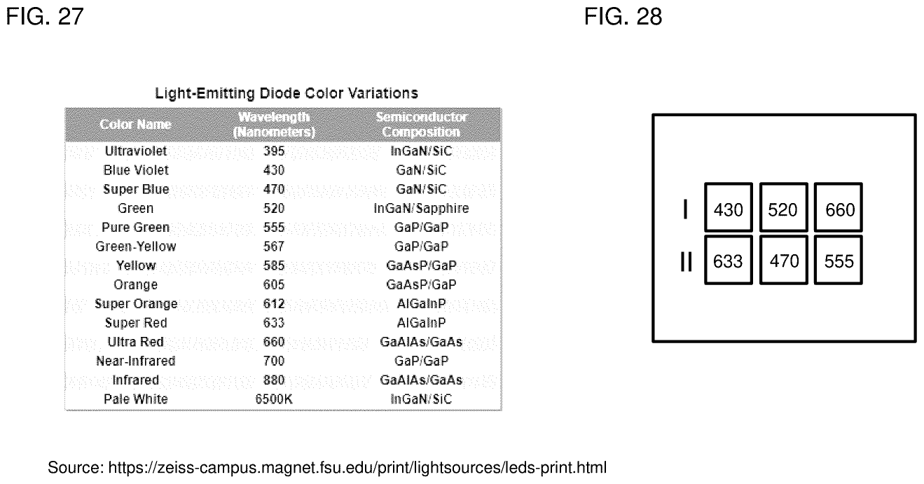

An alternative approach to generating an effectively broad-spectrum white illumination, described with reference to FIGS. 27-30C, employs two sets of RGB LEDs. Specific wavelengths of RGB can be selected from different semiconductor compositions, as exemplified in the table of FIG. 27. After selecting two blues, two greens and two reds with differing primary wavelengths, a matrix of 2 by 3 RGB LEDs can be fabricated, such as is illustrated schematically in FIG. 28, corresponding to two sets of RGB sources (I and II), each labeled with its primary wavelength in nanometers.

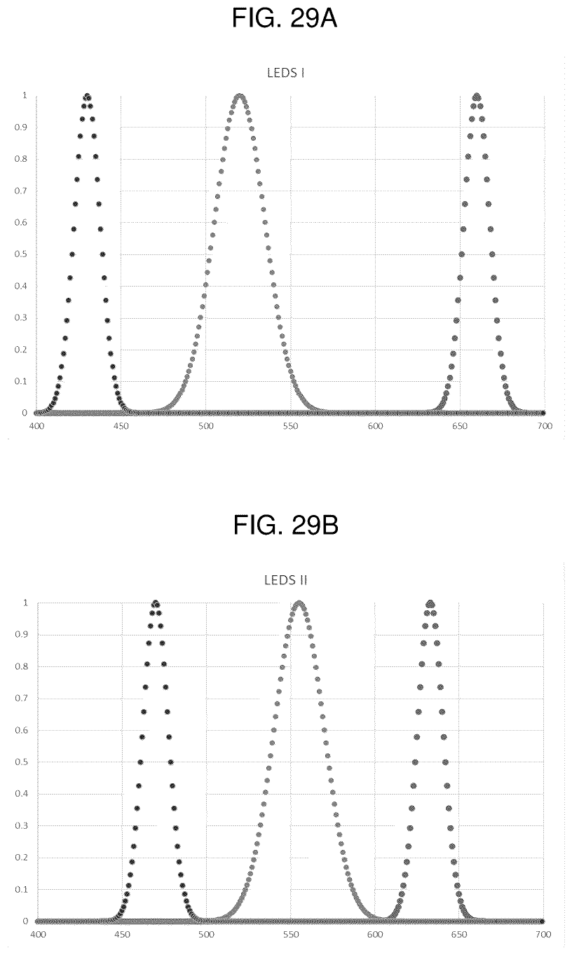

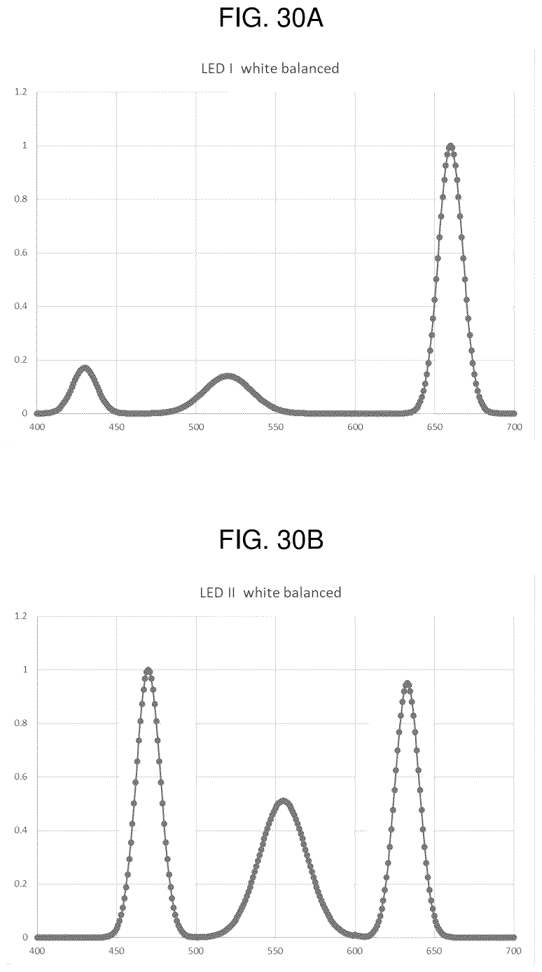

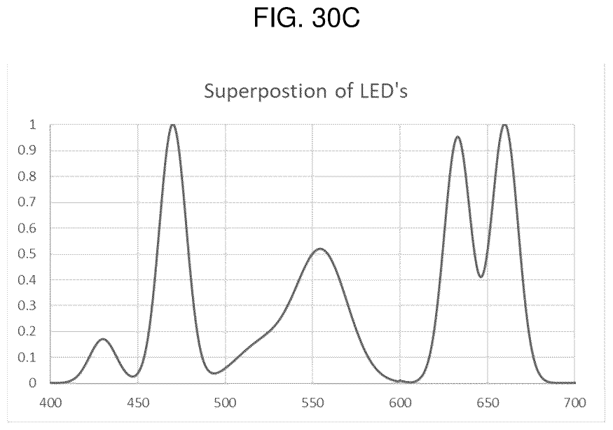

Each of the three RGB sources has a characteristic intensity vs. wavelength, which may be, for example, LEDs set I and LEDs set II features as illustrated in FIGS. 29A and 29B. In this example, it was chosen to balance the white of LED group I separately from LED group II, resulting in the spectra of FIGS. 30A and 30B. In the current example, the white balance process sets the RGB sources of group I and II to reach CIE chromaticity coordinates of x=0.333 and y=0.333, separately. When all six LED are actuated together, after this white balance adjustment, the resulting spectral characteristic graph is as shown in FIG. 30C.

The example here is just one illustration out of many different possibilities. The white balance doesn't have to be done as illustrated above but can be done after super position of all the LEDs together (LED I and LED II), or by separately balancing the two blues, two greens and two reds together. Another degree of freedom is choosing different LEDs wavelengths or using fewer LEDs. For example, in some cases, a set of only 5 LEDs may provide a sufficient spread of wavelengths and may be sufficient to achieve white balance.

A further option for employing an illumination source as illustrated in FIG. 28 is to combine pairs of sources of each color: two blues together, two greens together and two reds together. These may then be used in the conventional manner of illumination by RGB pulses, but with each color serving as a relatively wide-spectrum source. Optionally, the light source may be switchable between two modes: a “normal” mode in which only one LED for each color is employed, possibly providing more vivid color rendition, and a “white-rendering mode,” actuated selectively only when a large proportion (e.g., at least 20%) of the pixels of the image are set to white, which actuates the paired LEDs for each color, thereby enhancing the white uniformity. This approach may be used alone or may be combined with the various 4-pulse per frame illumination schemes of the other aspects of the present invention described below.

### Display Device Overview

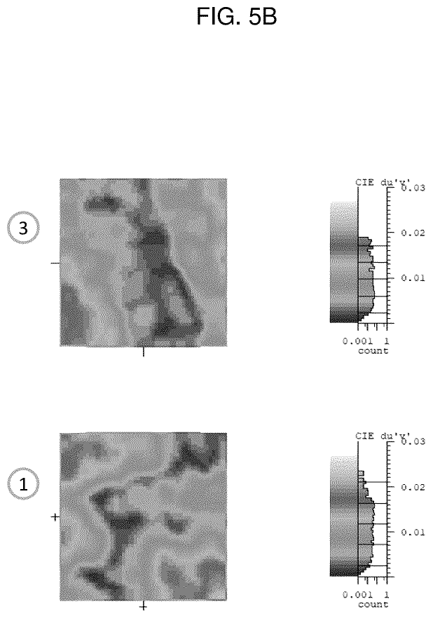

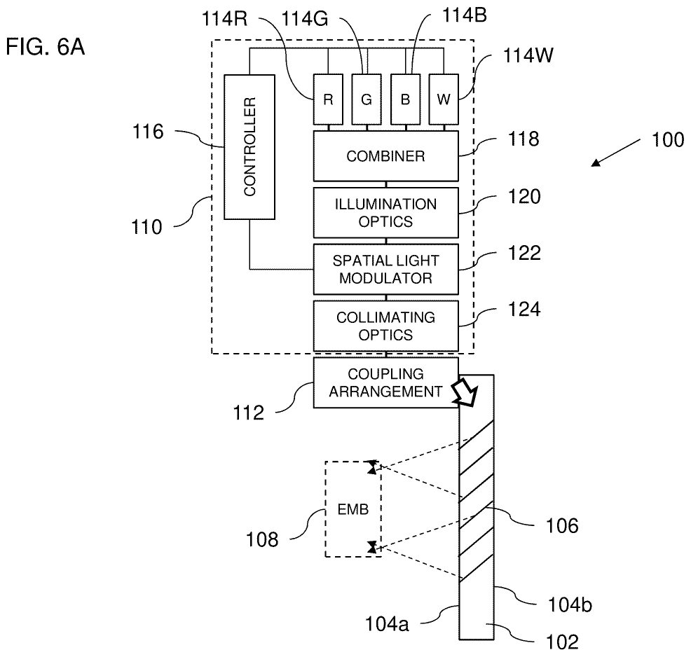

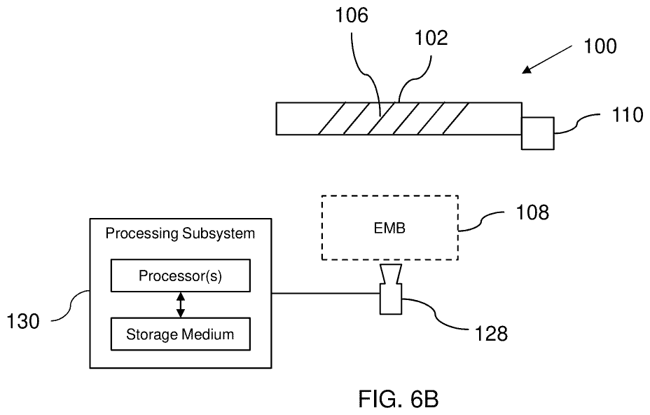

A preferred implementation of a display, generally designated 100, constructed and operative according to an aspect of the present invention, for presenting an image to an eye of a user, is shown schematically in FIG. 6A. In general terms, display 100 includes a lightguide optical element (LOE) 102 having a pair of mutually parallel major surfaces 104a, 104b for supporting propagation of light corresponding to an image by internal reflection. LOE 102 includes at least one set of mutually parallel partially reflecting coupling-out surfaces 106, internal to the LOE and angled obliquely to major surface 104a, for coupling out the light corresponding to the image towards the eye of the user located at an eye-motion box (EMB) 108. Display 100 also includes an image projector 110 optically coupled to LOE 102 via a suitable coupling arrangement 112 for introducing light corresponding to the image into LOE 102 so as to propagate within the LOE. Image projector 110 includes light sources of at least four distinct spectral properties including a red light source 114R, a green light source 114G, a blue light source 114B and a white light source 114W. A controller 116 is configured to actuate the image projector 110 to generate the light corresponding to the image. Controller 116 is configured to operate in at least a first mode in which at least part of an intensity of at least a subset of pixels of the image is generated by white light source 114W. The subset of pixels is most preferably the subset of pixels of the image which are set to white.

The word “white” in this context is not limited to “true white” with pixel values specifically of (255, 255, 255) but rather encompasses a range of color values spanning warmer and cooler whites and other “off-white” shades in which all three of the color components are high, for example above 230 (in an 8-bit color triplet) or otherwise above 90% of their maximum values, and where a single color value is used as a uniform background or otherwise appears across a significant part (defined by some threshold, which may be, for example, at least 20% or at least 30%) of the pixels of an image. In such scenarios, the variations in the chromatic response of the LOE for different pixel angles under illumination by narrow RGB laser or LED sources tend to be particularly noticeable and are significantly reduced by employing a white LED source for all or part of the white illumination, particularly when the white source is chosen to approximate to a continuous spectrum source, as described herein. The uniformity of the white pixels can be further enhanced by addition of white-balance corrective illumination for one or more specific groups of pixels or for individual pixels, as will be further described below.

Many aspects of the present invention may be applied to displays which employ a wide range of types of projector technology including, but not limited to, projectors employing a spatial light modulator (SLM), such as an LCOS (liquid crystal on silicon) chip, digital light processing (DLP) systems and scanning illumination systems. Thus, for example, features of the present invention relating to the use of white illumination to illuminate white image pixels so as to reduce chromatic variations across the field of view, and delivery of white-balance corrective illumination to different groups of pixels (discussed below) are equally applicable to a projector employing scanning illumination. For conciseness of presentation, the remainder of the description will illustrate implementations of the present invention in a non-limiting example of a projector based on an SLM image generation mechanism.

### Optical Test Setup

According to embodiments of the present invention, an optical setup (referred to interchangeably as an optical system) is used in order to first select the white light source (white LED) that is optimal (or nearly optimal) for use in the image projector with the optical coating design of the partially reflective surfaces of the LOE, as well as to select the optimal or near optimal illumination settings (e.g., intensities) of the selected white LED and the RGB LEDs or lasers for improved color uniformity in the generated images.

FIG. 6B shows a schematic representation of the optical system. Generally speaking, the optical system includes image projector 110 coupled to LOE 102, an optical sensing arrangement, such as a color camera 128, and a processing subsystem 130 including processor(s) 132 and a data storage medium 134.

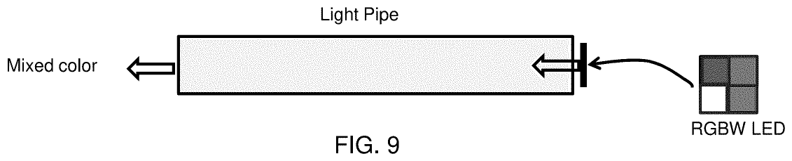

As shown in FIG. 6A, the image projector has a spatial light modulator (LCOS), light sources (RGB LEDs or lasers 114R, 114G, 114B and white LED 114W) that illuminate a spatial light modulator (e.g., LCoS) 122 to generate image illumination, and collimating optics 124 that collimates the image illumination. The illumination from the light sources is preferably combined by a combiner 118 (for which various implementations will be discussed below with reference to FIGS. 9-12) and directed toward SLM 122 in a desired spatial distribution by illumination optics 120. Illumination optics 120 and collimating optics 124 are often implemented in a known manner as reflective optical arrangements on the faces of polarizing beam splitter prisms (not shown) and will not be described here in detail.

The LOE 102 is formed from light-transmitting material (such as glass) and has a pair of parallel major external surfaces 104a, 104b to form a slab-type substrate, and in some implementations may have two pairs of parallel major external surfaces to form a rectangular cross-section. The LOE also includes a series of internal mutually parallel partially reflective surfaces 106 that are inclined obliquely to major external surfaces of the LOE. The optical coupling arrangement 112 is typically implemented as a reflective surface or a coupling prism that couples the collimated image illumination from the exit aperture of the image projector into the LOE such that the coupled-in image advances (propagates) through the LOE by internal reflection.

Parenthetically, implementation of the LOE as a slab-type LOE provides aperture expansion in one dimension, and implementation of the LOE as a rectangular cross-section LOE provides aperture expansion in two dimensions. It is noted that aperture expansion in two dimensions may also be provided using a slab-type LOE by employing two sets of internal mutually parallel partially reflective surfaces, where the partially reflective surfaces of one set are non-parallel to the partially reflective surfaces of the other set.

The optical sensing arrangement 128 includes at least one optical sensor that is operative to capture color images. The optical sensor is deployed in EMB 108 to capture the image illumination that is coupled out of the LOE by the partially reflective surfaces. The optical sensor effectively simulates the viewer's eye.

The processing subsystem 130 receives signals from the optical sensing arrangement and processes the received signals to determine the color of the coupled-out image in the color gamut (i.e., compute the color difference) when the display is actuated to display a uniform true-white image.

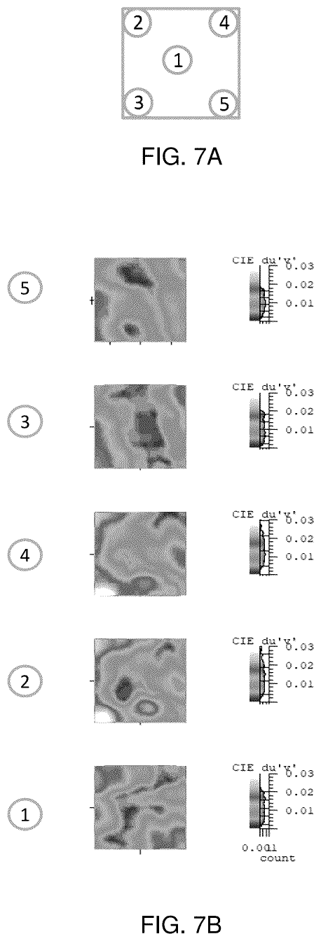

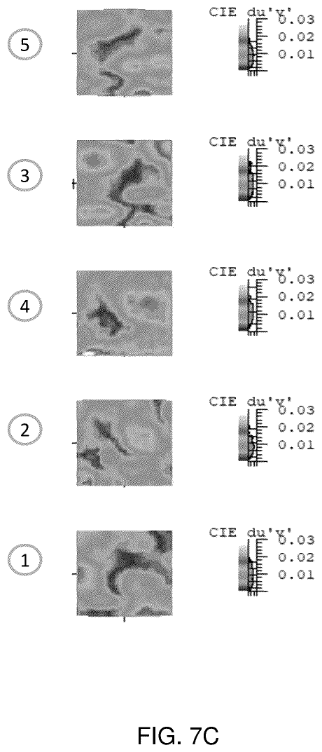

In certain embodiments, the optical sensing arrangement includes a single optical sensor that can be moved (automatically, semi-automatically, or manually) to different regions of the EMB. In other embodiments, multiple optical sensors can be deployed, each one at a different region of the EMB. In one practical implementation believed to be advantageous, illumination at five different regions of the EMB may be captured by the optical sensing arrangement. The five regions include the four corners of the EMB and the center of the EMB (as shown in FIG. 7A). It is noted, however, that the optimal selection of the white LED can alternatively be based on the color difference computed by the processing subsystem when the optical sensor is deployed to capture illumination from the center region of the EMB, which can typically be assumed to be a good approximation for the average eye location within the EMB.

Once the white LED is selected, having the optimal or near optimal spectral distribution for the particular coating design of the partially reflective surfaces of the LOE, adjustments can be made to fine-tune the intensities of the primary color components in order to achieve an ideal (or near ideal) spectral distribution (i.e., continuous spectrum), such as the spectral distributions illustrated in slides 8 and 9. This process can be by trial-and-error and in certain cases performed manually. However, automation of the trial-and-error process can dramatically improve the efficiency of the process for identifying the requisite intensities.

FIG. 7B shows, for each of the five regions of the EMB in FIG. 7A, the color difference (as computed by the processing subsystem) for white color produced by the RGB LEDs or lasers. FIG. 7C shows, for each of the five regions of the EMB in FIG. 7A, the CIELUV color difference (as computed by the processing subsystem) for white color produced by a conventional white LED (e.g., a white LED that produces white light having a spectral distribution as illustrated in FIG. 2). As should be apparent, there is an improvement in the uniformity of the white color when using a conventional white LED across any of the five regions of the EMB. However, the improvement is even more significant when utilizing a white light source that produces white light having a spectral distribution as illustrated in FIGS. 3A, 4A, or 5A. FIGS. 3B, 4B and 5B show the color difference (as computed by the processing subsystem) for white color produced by white light source having spectral distribution as illustrated in FIGS. 3A, 4A, and 5A, respectively. In FIG. 3B, the upper image is the computed color difference for the bottom left of the EMB (i.e., region ‘3’ in FIG. 7A), and the lower image is the computed color difference for the center of the EMB (i.e., region ‘1’ in FIG. 7A). In FIG. 4B, the computed color difference is shown for each of the five regions of the EMB labeled in FIG. 7A. In FIG. 5B, the upper image is the computed color difference for the bottom left of the EMB (i.e., region ‘3’ in FIG. 7A), and the lower image is the computed color difference for the center of the EMB (i.e., region ‘1’ in FIG. 7A). In each case, color differences of up to 0.01 (red, yellow and green shading) are typically considered acceptable image quality, whereas the higher values, shaded in cyan, blue or magenta, indicate more significant offsets which may correspond to more noticeable chromatic distortion.

### In Operation

As discussed above, CSD-based display devices (e.g., LCoS-based displays), the display transmits primary color information (e.g., red, green, blue) in successive images (pulses) at a high frame rate and relies on the human vision system to combine the primary color images into a single image of true colors. In some cases, a single illumination cycle includes an illumination sequence of three pulses (red pulse, green pulse, blue pulse), however in other cases an illumination sequence can include four or more pulses, red pulse, green pulse, green pulse, blue pulse. The number of pulses may also depend on the structure of the illumination sources. For example, in implementations where the illumination source includes two green sub-LEDs or lasers, then a typical illumination cycle could be red pulse, green pulse, green pulse, blue pulse.

According to embodiments of the present invention, the selected white LED is incorporated into the image projector such that the image projector includes RGB illumination sources plus the selected white light (LED) source. The image projector control electronics (e.g., microcontroller) can be programmed to operate such that, when necessary, a fourth pulse, that includes white illumination from the white LED in combination with illumination from the RGB LEDs or lasers (if needed), is generated.

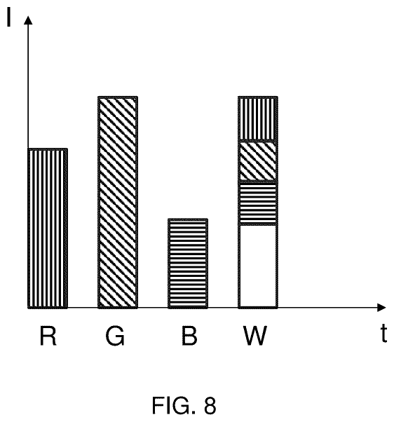

FIG. 8 illustrates an exemplary illumination sequence of the four pulses. In the drawing, the first three pulses (RGB pulses) are used to generate all of the non-white pixels of the image, and optionally also white pixels that do not require accurate white color. Any accurate white object and/or pixel, or uniform white background, is generated by the fourth pulse, which may be generated by the white LED alone, or more preferably, by combining the white LED together with the RGB LEDs or lasers.

In embodiments in which the image projector, before adding the white LED, conventionally operates according to a four-pulse illumination cycle (e.g., red pulse, green pulse, green pulse, blue pulse), the image projector control electronics can be re-programmed to replace one of the green pulses with the white pulse (white color obtained by combining the white LED together with the RGB LEDs or lasers). In such embodiments, the peak intensity of the remaining green pulse could be doubled in order to compensate for the missing second green pulse.

In embodiments in which the image projector, before adding the white LED, conventionally operates according to a three-pulse illumination cycle (e.g., red pulse, green pulse, blue pulse), a hardware modification to support a higher sequence frequency, shorter pulse durations, and higher intensity peaks, may be required, in addition to re-programming of the image projector control electronics.

### Image Projector Architecture

Referring again to FIG. 6A, the image projector 110 according to certain preferred embodiments of the present invention employs illumination sources 114R, 114G, 114B and 114W (i.e., RGB LEDs or lasers, as well as a white LED), a spatial light modulator 122 such as an LCOS chip that applies spatial light modulation to the LED illumination, and collimating optics 124 that collimates the modulated illumination, typically all arranged on surfaces of one or more PBS cube or other prism arrangement. In practice, the illumination from the light sources (white LED plus RGB LEDs or lasers is mixed/combined by a combiner 118 prior to reaching the LCOS panel such that the light that illuminates the LCOS is color mixed or combined light.

There are various approaches to achieving color mixing, for example by use of light pipes, beamsplitters, polarizers, dichroic surfaces, and combinations thereof. FIG. 9 illustrates as one non-limiting example an approach to color mixing using a light pipe. Here, the RGBW light sources (e.g., white LED plus RGB LEDs or lasers) are provided on a single chip at the input to the light pipe, and mixed color is produced at the output of the light pipe. The components of light (RGBW) that illuminate the LCOS should all be of the same polarization with regards to the LCOS panel, and therefore a polarizer may be deployed at the output of the light pipe to operate on the incident mixed RGBW light to produce polarized light.

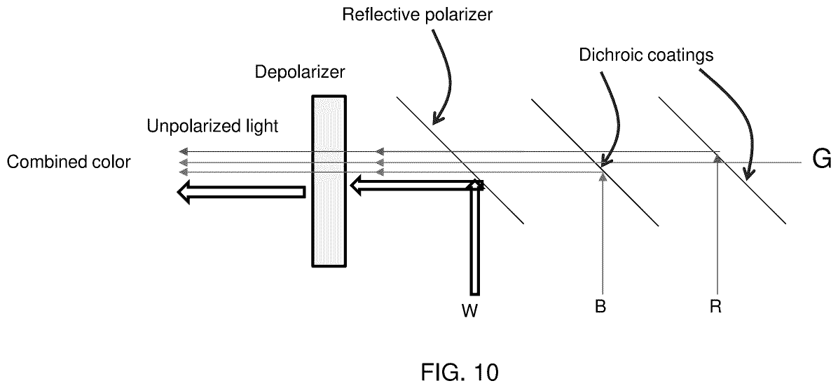

FIG. 10 illustrates as another non-limiting example an approach to color mixing using a combination of: 1) a reflective polarizer that transmits or reflects incident illumination based on the polarization state of the incident illumination with regards to the reflective polarizer, and 2) a pair of dichroic surfaces (i.e., dichroic coatings) that transmit or reflect incident illumination based on the color of the incident illumination and the polarization state of the incident illumination with regards to the dichroic surface. Here, the first (right-most) dichroic surface transmits green light that is s-polarized with regards to the first dichroic surface and reflects red light that is s-polarized with regards to the first dichroic surface, and the second (left-most) dichroic surface transmits green light and red light that is s-polarized with regards to the second dichroic surface and reflects blue light that is s-polarized with regards to the second dichroic surface. The reflective polarizer (which can be implemented as a PBS configuration having a PBS surface) transmits light that is s-polarized with regards to the reflective polarizer surface and reflects light that is p-polarized with regards to the reflective polarizer surface. In the example illustrated in FIG. 10, the configurations of the light sources, reflective polarizer, and the dichroic surfaces are such that the combined RGBW light has mixed polarization (the white light is p-polarized, whereas the RGB light is s-polarized). As mentioned above, the components of light that illuminate the LCOS should all be of the same polarization with regards to the LCOS panel, and therefore a depolarizer is deployed at the output of the reflective polarizer to operate on the incident p-polarized white light and the incident s-polarized RGB light to produce unpolarized RGBW light. Although not shown in the drawing, a polarizer can then be deployed downstream from the depolarizer to polarize the unpolarized RGBW light (prior to the light reaching the LCOS).

It should be apparent that color combining can be achieved using any number of variations of the implementation illustrated in FIG. 10. For example, the locations of the colored light sources can be rearranged, and the polarization and color selective properties of the dichroic surfaces modified as needed.

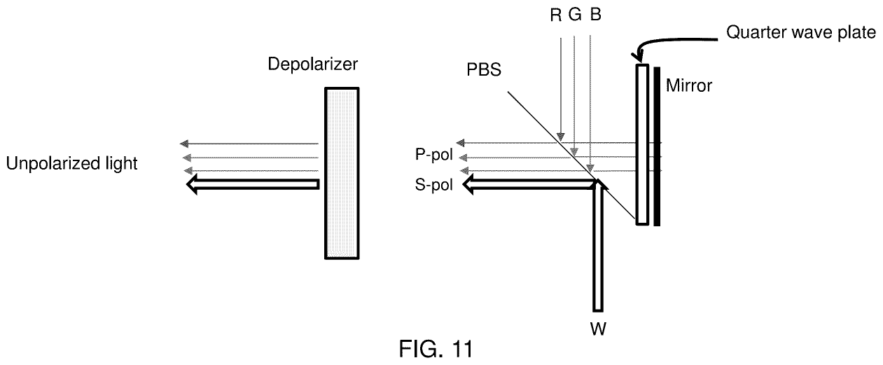

FIG. 11 shows another non-limiting example architecture. Here, a PBS configuration (which can be part of a PBS cube or other type of prism) is deployed such that the PBS surface of the PBS configuration is at approximately a 45-degree angle relative to a retarder (illustrated here as a quarter wave plate or QWP) that is associated with a reflective surface (i.e., mirror). The PBS surface reflects light that is s-polarized with regards to the PBS surface and transmits light that is p-polarized with regards to the PBS surface. Here, the RGBW sources produce light that is s-polarized with regards to the PBS surface. The s-polarized white light produced by the white LED reflects from the PBS surface, for example toward a depolarizer. The s-polarized RGB light produced by the RGB LEDs or lasers reflects from the PBS surface and then passes through the QWP and reflects from the mirror that is behind the QWP back through the QWP. This double-pass through the QWP effectively rotates the polarization state of the RGB light from s-polarization to p-polarization with regards to the PBS surface. The now p-polarized RGB light is transmitted by the PBS surface, for example to the depolarizer. The depolarizer operates on the incident s-polarized white light and the incident p-polarized RGB light to produce unpolarized light. Similar to as described with reference to FIGS. 9 and 10, a polarizer can be deployed prior to the input to the LCOS to polarize the unpolarized RGBW light (prior to the light reaching the LCOS).

FIG. 12 shows another non-limiting example architecture that is similar to FIG. 11, except here the RGB LEDs or lasers produce light that is p-polarized with regard to the PBS surface and no QWP or reflective mirror are employed because the RGB LEDs or lasers are deployed where the QWP/mirror would otherwise be. Thus, the p-polarized RGB light is transmitted by the PBS surface, and the s-polarized white light is reflected by the PBS surface (as before in FIG. 11). Similar to as described with reference to FIGS. 9-11, a polarizer can be deployed prior to the input to the LCS to polarize the unpolarized RGBW light (prior to the light reaching the LCOS).

It is noted that each of the RGBW light sources can be a source that produces polarized light or can be a source that produces unpolarized light where a polarizer is deployed at the output of the light source to polarizer the produced light. It is also noted that for each instance where a particular polarized light path has been followed in the examples described herein, the polarizations are interchangeable, whereby, for example, on altering the polarization and/or color selective properties of the PBS, reflective polarizer and dichroic coatings, each mention of p-polarized light could be replaced by s-polarized light, and vice versa.

### Active White Balance Correction

The test setup described above with reference to FIG. 6B preferably generates maps of color offset distance for pixels over the entire field of view that are set to pure white at one location in the eye-motion box, and preferably at a range of positions. In addition, or as an alternative, to assessing and optimizing the choice of white illumination, the mapping of color offset opens up the possibility of performing active white balance correction for groups of pixels, or even individual pixels, as will now be discussed.

Thus, according to a further feature of the present invention, controller 116 is configured to operate in at least a first mode in which it:
(i) receives pixel image data corresponding to an image to be displayed;
(ii) identifies within the pixel data a subset of pixels that are set to a uniform white;
(iii) generates modified pixel data in which data for at least the subset of pixels are modified to correct for chromatic aberration introduced by the LOE; and
(iv) actuates the image projector to generate the image according to the modified pixel data.

The modified pixel data are preferably generated based on a calibration map of chromatic aberration introduced by the LOE for white light reaching an eye motion box from which the image is to be viewed, and most preferably as a function of the eye position from calibration maps of chromatic aberration introduced by the LOE for white light reaching multiple locations within the eye motion box 108. The pixels may then be classified into a number of groups which has similar color offsets, and each group is illuminated by the white light source plus a corresponding white-balance corrective illumination from the red light source, the green light source and/or the blue light source.

This approach is applicable to an image projector that includes a plurality of scanned laser beams and can be implemented with a conventional RGB scanning arrangement employing three scanned beams. Alternatively, an implementation employing an additional white light scanned beam for providing at least part of the light for the white pixels may provide additional advantages, analogous to the broad spectrum illumination described above.

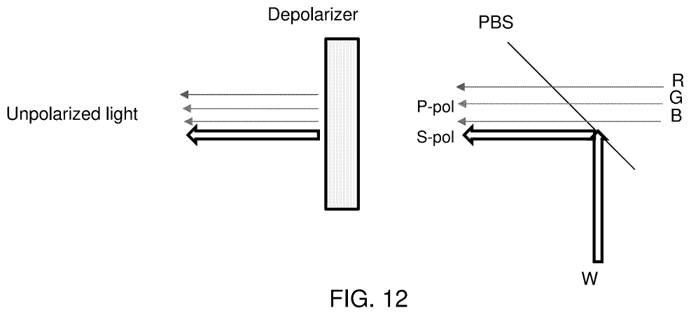

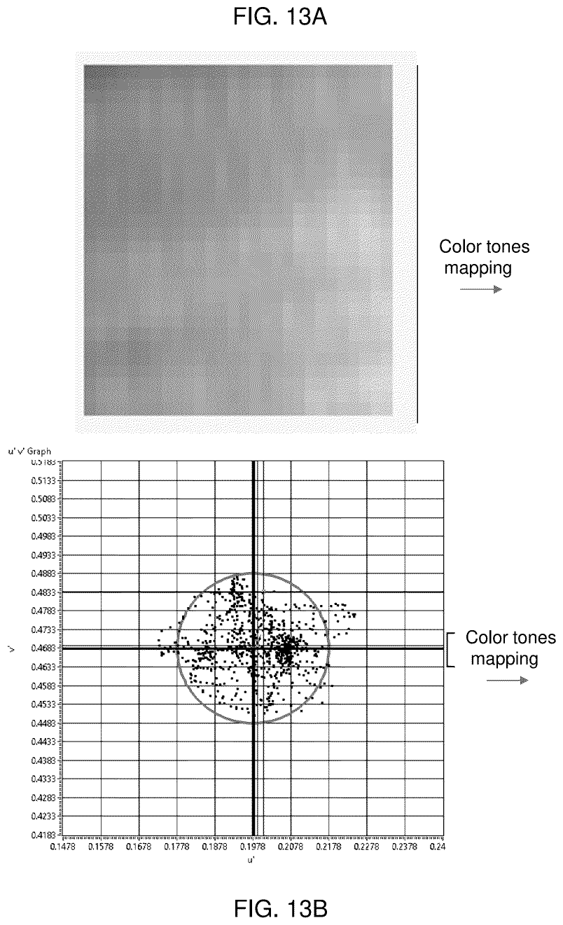

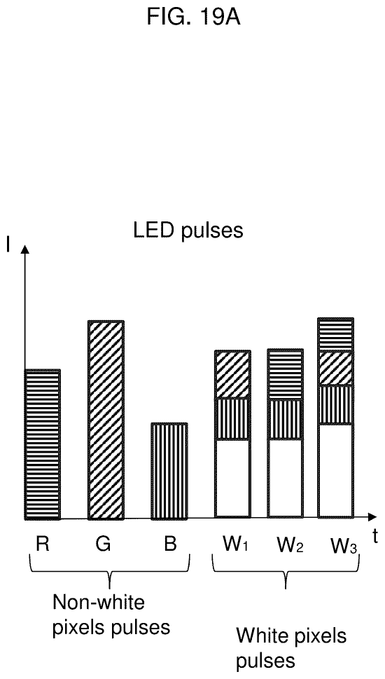

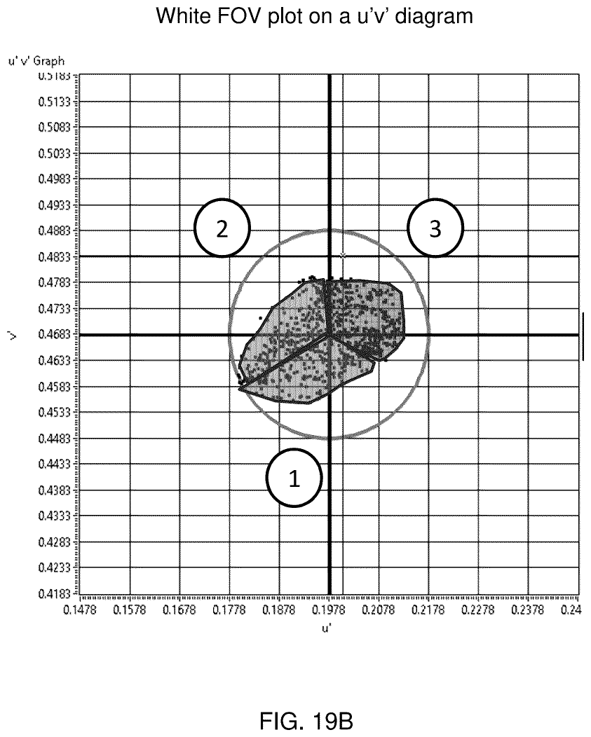

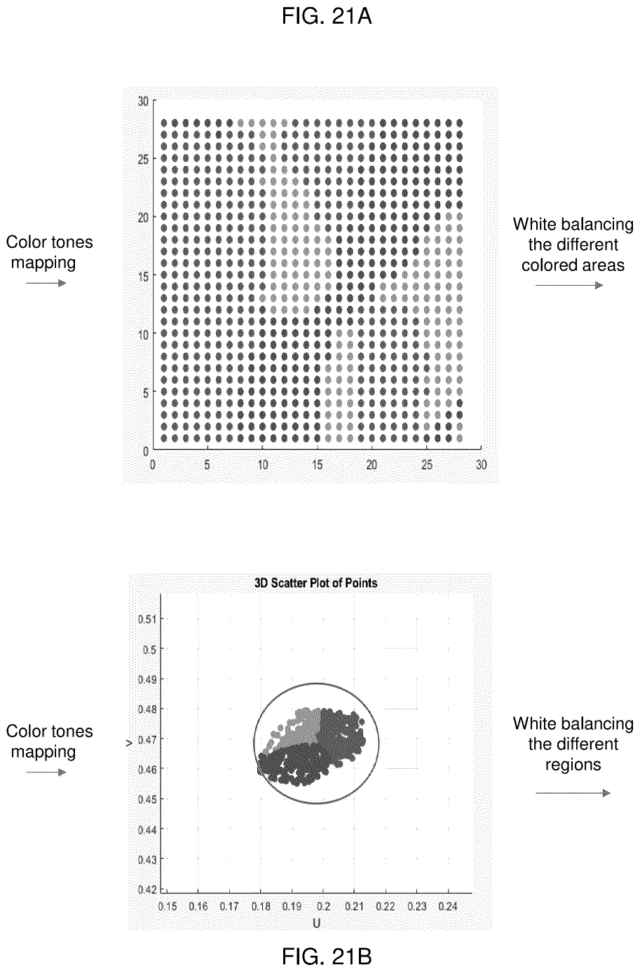

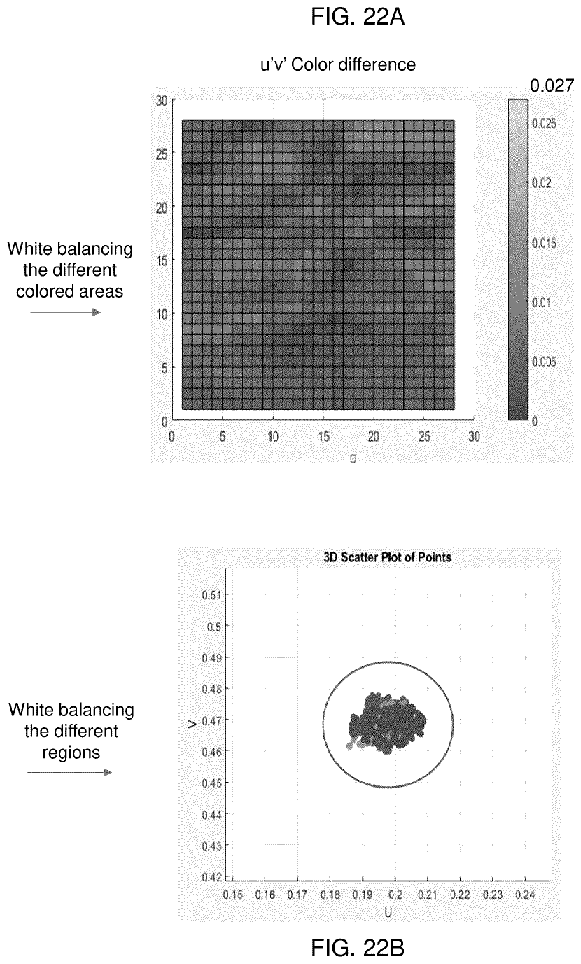

The primary implementations illustrated here relate to an image projector that includes a spatial light modulator (SLM) 122. When in the first mode, the controller most preferably actuates the light sources to sequentially illuminate the SLM with pulses of light from the red, green and blue light sources and with a pulse of white light. In certain implementations, the pulse of white light may be generated by simultaneous operation of the red, green and blue light sources, without a dedicated white light source, as will be illustrated with reference to FIGS. 13A-18B. In certain particularly preferred implementations, the pulse of white light is generated at least in part by a white light source, such as the near-continuous spectrum white light sources discussed above, as will be illustrated in FIGS. 19A-24B.

Turning first to FIGS. 13A-15B, FIG. 13A illustrates the variation in color tone in an exemplary display which has all pixels set to white and shows visually apparent variations in color. FIG. 13B is a plot of a cloud of points (scatter plot) corresponding to the spread of the color tones of pixels and their distance from white (the center). This is measured with a color camera or a colorimeter. Suitable software is used to determine the color coordinates for each pixel. The color coordinates are displayed on a CIE color space. In our case, a U′V′ CIE color space is used. The coordinates of the center of the circle in FIG. 13B are for a perfect D65 white color. The distance from a point to the center of the circle expresses the white performance of each pixel. The smaller the distance, the closer the pixel is to true white.

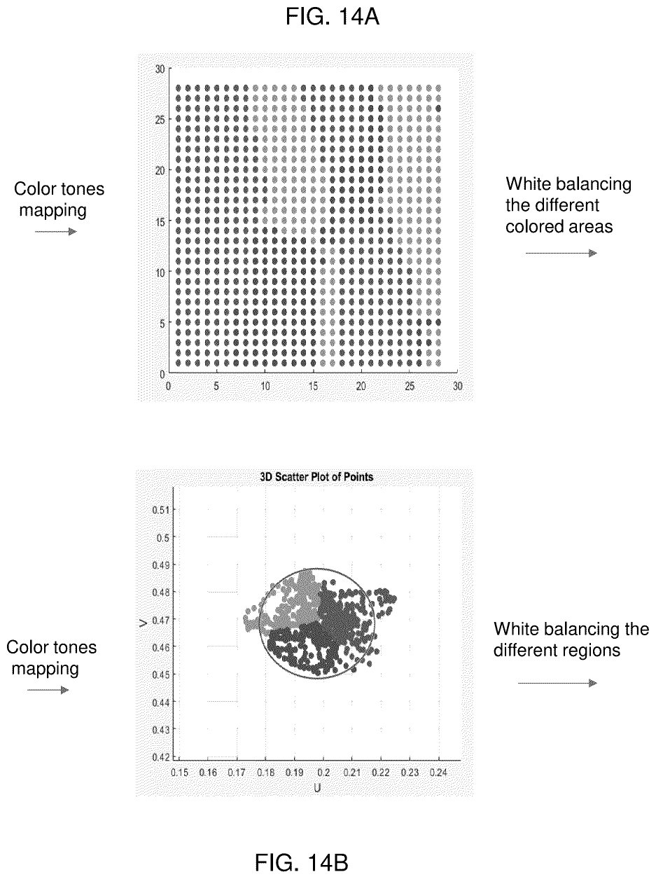

In FIG. 14A, the pixels are subdivided into subsets which have a similar direction of color tone offset. In this case, three subsets are used, denoted here by colors red, green and blue. FIG. 14B illustrates the cloud plot with the pixels denoted by the corresponding colors. According to this aspect of the present invention, these subsets of pixels are illuminated using modified white illumination pulses, where the illumination pulse for each subset of pixels is modified to move the center of each subset towards the center of the color offset plot. Where a white light source is used, the modified white pulse is typically a combination of a pulse from the white light source and white-balance corrective illumination from some combination of the red, green and/or blue light sources.

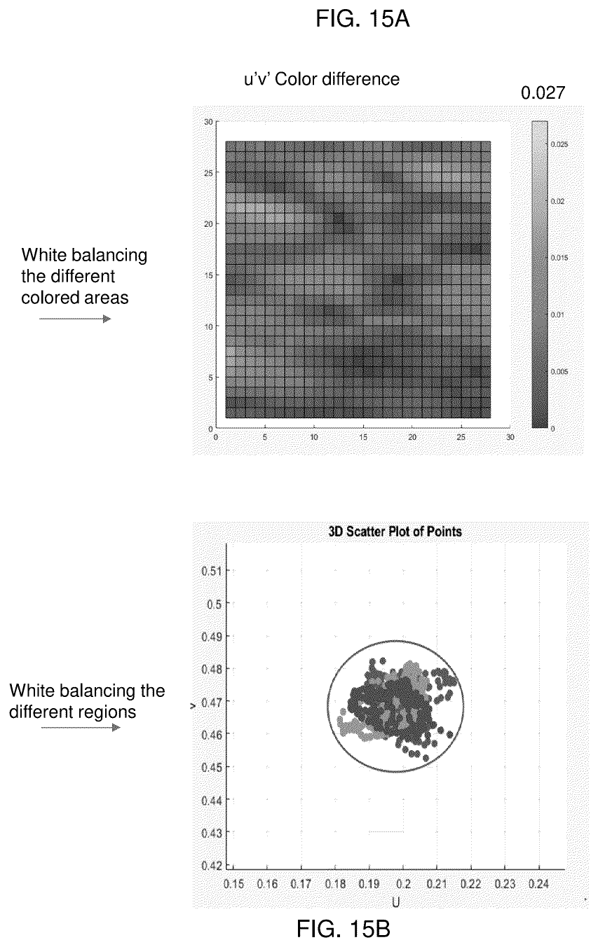

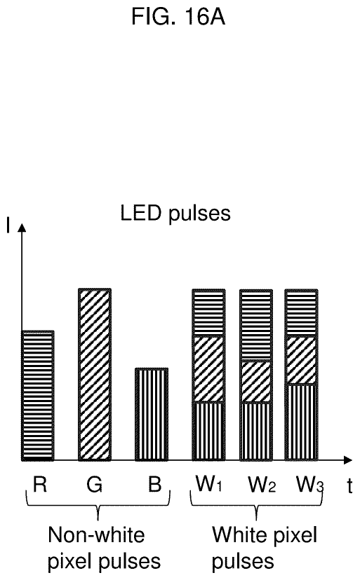

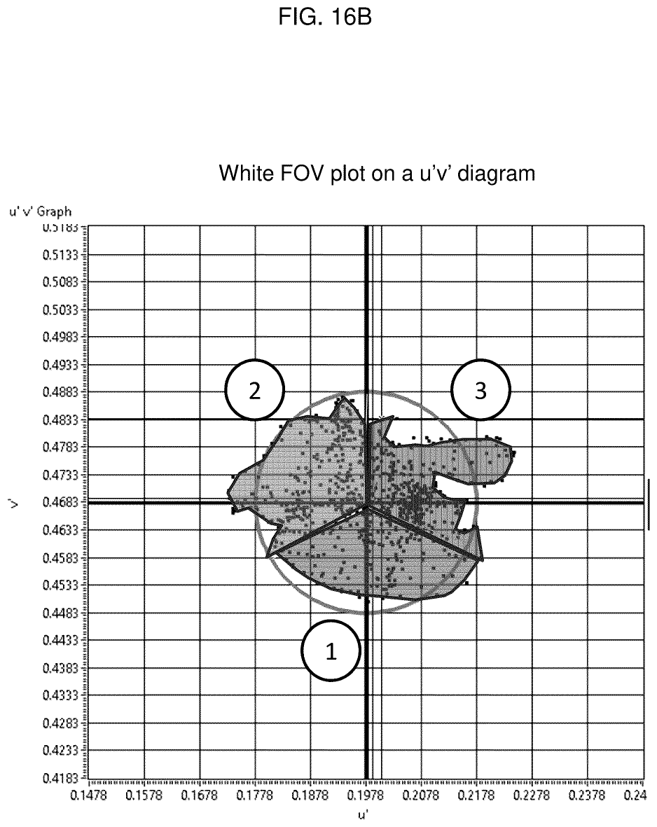

One implementation of this approach is illustrated schematically in FIGS. 16A and 16B. Pixels which are not set to white are illuminated in the normal manner, with separate red, green and blue pulses which illuminate the spatial light modulator (SLM) while it is set to the required illumination for each of the RGB values. Pixels which are set to white are illuminated during separate pulses, one for each subset. Thus, the subset of pixels with a color tone offset lying in the area (1) shaded blue in FIG. 16B are actuated (bright) during a first white pulse W1, made up with relatively more green than red, the subset of pixels with a color tone offset lying in the area (2) shaded green are actuated (bright) during a second white pulse W2, made up with relatively more red than green, and the third subset of pixels with a color tone offset lying in the area (3) shaded red are actuated (bright) during a third white pulse W3, which has a relatively larger intensity of blue compared to red and green. The exact proportions of each color used to make up each pulse are determined according to the illumination required to move a centroid of the corresponding area to be at the center of the color tone plot, as illustrated schematically in FIG. 15B. This results in a significant improvement to the uniformity of the white display, as illustrated in FIG. 15A, where the color difference offset is represented by the color scale as illustrated.

It will be noted that the underlying scatter plot of FIG. 16B is less dense than the calibration scatter plot of FIG. 13B, since this plot includes only the pixels of the current image which are set to white. Additionally, although the calibration process of FIGS. 13A-15B is preferably performed with pure white (D65) illumination, the color balance correction may be performed for “white” pixels according to the broader definition above, wherever a single tone of white or off-white is used as a uniform background or otherwise appears as significant continuous areas of the image. The modified white pulses are adjusted to reflect the desired pixel color, but the correction is still based on the same color offset correction vector which optimizes display of pure white, which will typically also be effective to optimize fidelity and uniformity of display for other near-white tones.

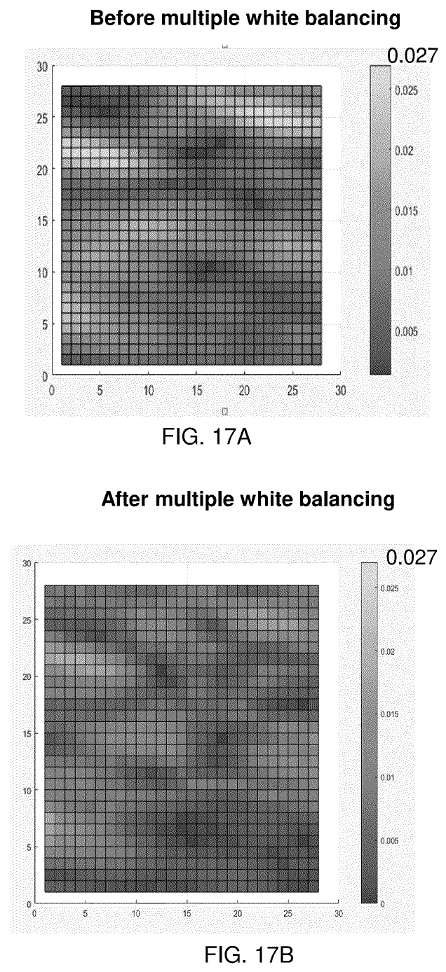

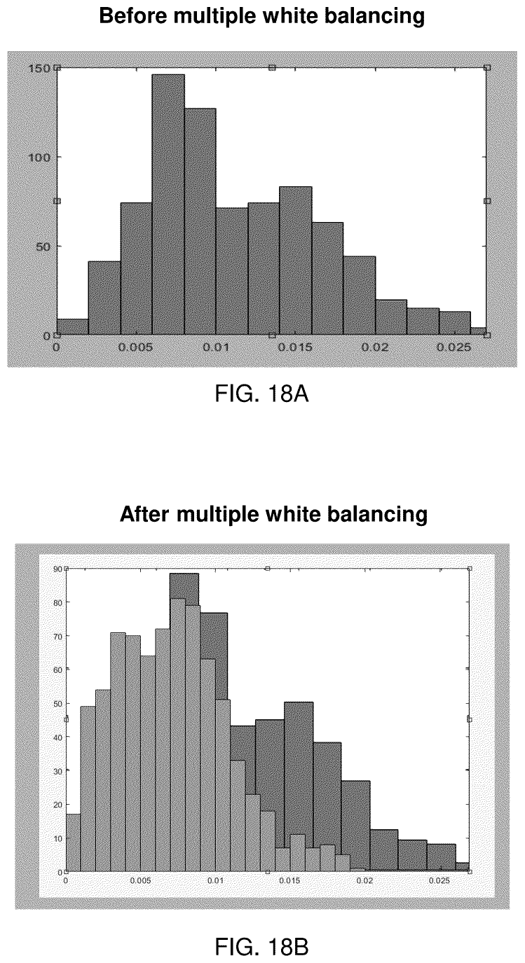

FIGS. 17A and 17B juxtapose this color-coded map of color difference offset of pixels from white with, and without, the corrective white illumination according to this aspect of the present invention. FIG. 17A is generated by conventional successive illumination by red, green and blue with all pixels set to full brightness. FIG. 17B is generated with successive illumination by three corrective-white pulses, with each pulse being delivered while the corresponding subset of pixels is bright, and the remaining pixels are dark. FIG. 18A is a histogram of the color tone offsets in FIG. 17A (number of pixels in each color offset subrange), while the superimposed blue histogram of FIG. 18B illustrates the compression of the histogram towards the left (reduced color offset) resulting from the corrective light pulses, indicating enhanced uniformity of the display.

The overall sequence of projecting image frames according to this scheme, best understood with reference to FIG. 16A, is therefore typically as follows:
Load image data to SLM for red color separation (all pixels that are not white) and illuminate with red illumination pulse;
Load image data to SLM for green color separation (all pixels that are not white) and illuminate with green illumination pulse;
Load image data to SLM for blue color separation (all pixels that are not white) and illuminate with blue illumination pulse;
Actuate first subset of white pixels of SLM to full intensity and illuminate with W1 modified white illumination pulse;
Actuate second subset of white pixels of SLM to full intensity and illuminate with W2 modified white illumination pulse; and
Actuate third subset of white pixels of SLM to full intensity and illuminate with W3 modified white illumination pulse.

The order of the illumination pulses is not critical, since the eye integrates the rapid succession of illumination pulses which all occur within a single frame period.

Although illustrated here in a non-limiting exemplary embodiment in which the color tone offset pattern is subdivided into three subsets and denoted using colors red, green and blue, it should be noted that the subsets do not necessarily correspond to color tone offsets that are aligned with the primary color axes. In certain cases, the direction of the offset and the corresponding white-balance correction in color space is chosen according to the distribution of the color tone offsets so as to optimize the results of the correction. Furthermore, the number of subsets and the corresponding number of modified white pulses used may vary from two up to three or four. In the case of two subsets, the longest axis of the color-tone offset distribution is preferably identified, and the subsets chosen to subdivide that length. The direction of the longest axis determines the color correction which should be made in the corrective-white illumination pulses. Use of more than three subsets of pixels, each with its own corrective-white illumination pulse, may allow further enhancement of the uniformity of white pixels, but at the expense of reduced energy efficiency, since each pulse is used to illuminate a reduced number of pixels. Optionally, one of the distinct subgroups may be the “on-axis” group of pixels with small color offset from white, and for which a balanced white illumination pulse is used. This allows the use of a larger correction for the off-axis regions.

The variations in white balance across the field of view vary according to the viewing position of the eye within the eye-motion box (EMB). Accordingly, to optimize the uniformity enhancement, a white image is preferably scanned at different positions within the EMB. Depending on the size of the EMB and the properties of the display, it may be preferred to scan the field of view as seen from, for example, a matrix of locations in the eye-motion box, for example, a 3×3 matrix. Alternatively, 5 reference points such as illustrated in FIG. 7A may be used. The measured values for each pixel, or more preferably, scaling factors corresponding to the required correction for each pixel, are then stored for each viewing location, as a look-up table. A look-up table can then be generated enabling an effective white compensation for different users according to each user's inter-pupillary distance (IPD). The position of the user's eye within the EMB can be estimated based on IPD, directly measured, or can be detected by an eye tracking system. Optionally, interpolation may be used between the specific EMB locations which were sampled.

It should be noted that this mapping of variations in white balance across the field of view, and according to the eye location within the EMB, may also be used to advantage in display systems with a scanning image generation mechanism, such as scanning of RGB modulated laser beams. The eye-position-dependent color balance data may be used to advantage to perform per-pixel color balance correction during the scanning process.

In order to limit the loss of efficiency due to the use of additional pulses, the unique mode of operation with multiple white balancing pulses may be activated selectively, only when the number of white pixels in the image exceeds a predefined threshold. For example, when at least 20%, or in some cases at least 30%, or at least half of the image pixels are white, the control system switches to the white-balancing mode to generate a more accurate white color. The user experience is thus improved, especially when a white background is needed, like for a website page. The above threshold is used as a “non-uniformity visibility criterion” below which it is assumed that the user experience will not be affected by the lack of white color accuracy, and the system reverts to the conventional three-pulse-per-frame RGB mode, thereby avoiding loss of energy on additional pulses for white correction. As indicated above, the non-uniformity visibility criterion need not be triggered only by pure white pixels, and may instead be actuated whenever the corresponding threshold number of pixels has the same near-white color setting, where each color component is above 90%, or in some cases 95%, of its maximum value. The proportion of pixels set as the threshold may vary from application to application, or according to user preferences or system setting for power saving vs. performance.

Turning now to FIGS. 19A-24B, certain particularly preferred implementations of the present invention combine both the first and second aspects of the invention, employing a broader-spectrum white light source to provide part of the corrective white illumination pulses for each subset of pixels according to the second aspect of the invention.

In this case, the color tone offset scatter plot is generated using the broader-spectrum white light source, thereby achieving an improved baseline spread as illustrated in FIG. 19B. It can be seen that the uncorrected point scatter is here more compact than the initial distribution of FIG. 16B since it falls fully within the reference circle that is the same in both diagrams. The corrective white illumination pulses are then generated by providing a primary pulse from the white light source, and supplementing with one or more of the RGB light sources to provide the required correction for each subset of pixels. This is illustrated schematically in FIG. 19A. As discussed before, the white light source may advantageously be a source with an apparent temperature of about 4,000 K, supplemented by a super blue source or longer wavelength.

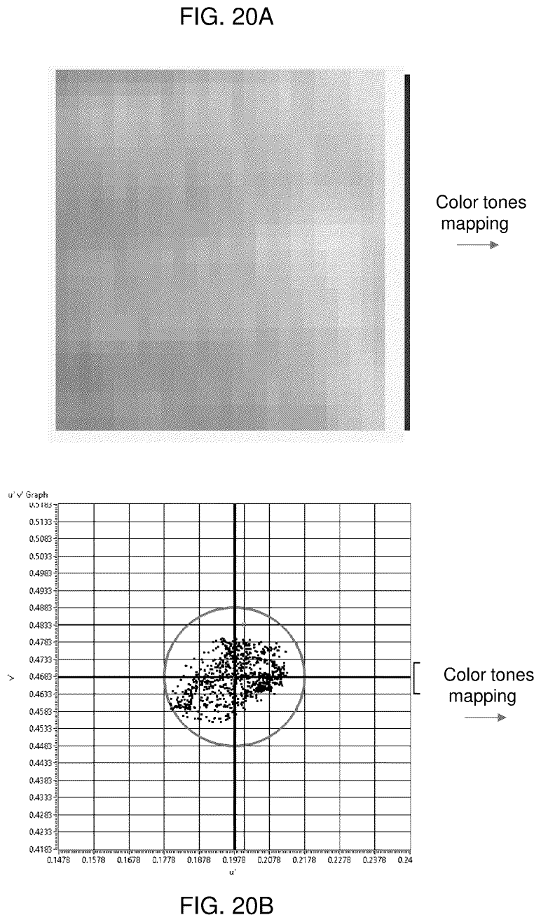

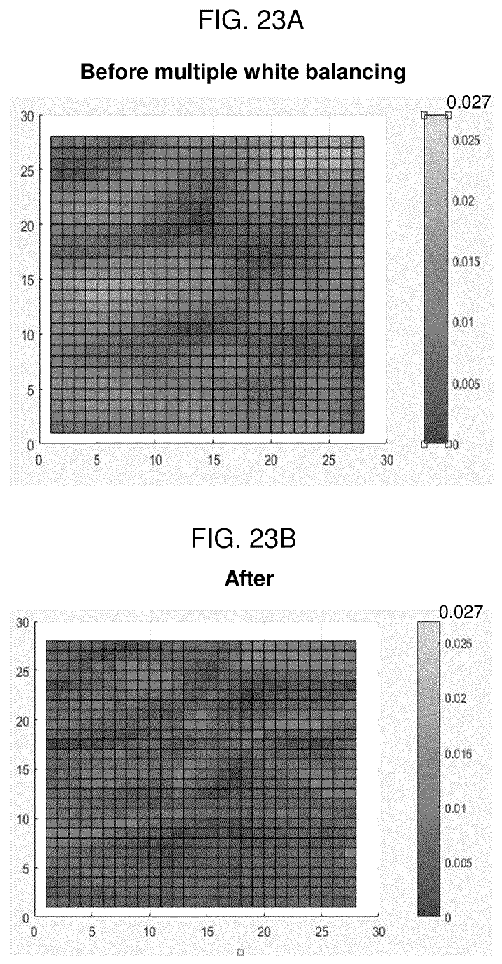

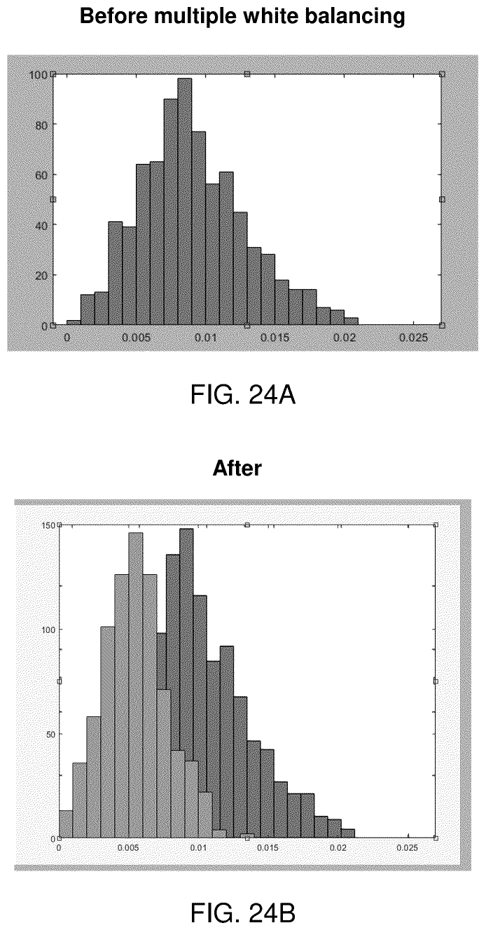

FIGS. 20A-22B are fully analogous to FIGS. 13A-15B, respectively, and FIGS. 23A-24B are fully analogous to FIGS. 17A-18B, respectively, all illustrating the case of illumination employing a broader-spectrum white light source to provide part of the corrective white illumination pulses. By comparing FIGS. 23B and 24B with 17B and 18B, it will be noted that a further enhancement of the white uniformity correction is achieved by combining the two aspects of the present invention.

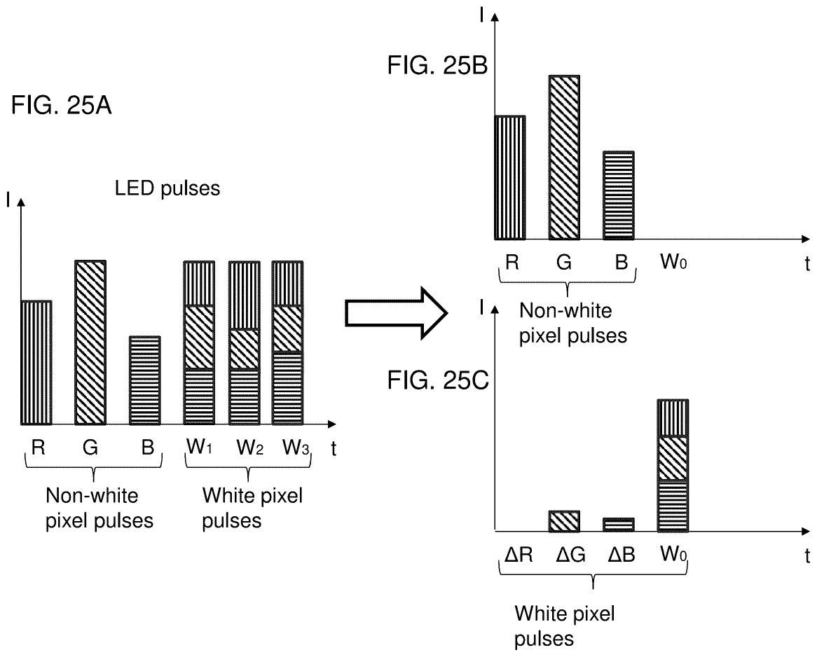

Turning now to a further aspect of the present invention, it is noted that illumination of each pixel resulting from 6 pulses (RGB plus three different corrective white pulses) in FIG. 25A (corresponding to FIG. 16A, above) can be achieved with higher efficiency using only 4 pulses, as illustrated in FIGS. 25B and 25C. Specifically, for non-white pixels, the RGB pulses may be used in the conventional manner to render the desired color, as illustrated in FIG. 25B (showing the reflected intensity for one arbitrarily selected pixel according to the corresponding RGB settings of that pixel). In order to render the white pixels during the same frame period as FIG. 25B, a fourth pulse labeled W₀ is delivered to provide simultaneously the RGB components that are common to all of the white pixels, and the residual corrections ΔR, ΔG and ΔB required for each group of pixels, or for individual pixels, are delivered by setting the pixel intensity to the required level for each of the separated RGB pulses. This is illustrated in FIG. 25C, for one arbitrarily selected white pixel for which the correction does not require any additional red. The required residual correction, in terms of the selection of colors and the intensity of each, may be set according to subsets of pixels requiring similar corrections, as was described above. However, since the chromatic correction is here performed by setting each pixel individually during the RGB pulses, this implementation opens up the possibility of setting the chromatic correction on a per-pixel basis (i.e., where the “groups” of pixels for each correction each contain a single pixel) according to the correction required for that pixel from the current viewing location. Scaling factors, or absolute values of the required corrective corrections, for each pixel as viewed from different regions of the eye motion box (EMB) to achieve correct white balance are preferably stored in look-up tables.

For white pixels, the intensity of the pixels during the white pulse is typically set to 100%. Optionally, this 4-pulse display sequence may also be used to provide enhanced color fidelity for relatively bright pixels that are not white, where the common RGB components are provided by setting the intensity value of the pixel accordingly during the white pulse, and the remainder of the RGB components are set according to the residual values to deliver the desired color of the pixel with corrected color balance. Due to the 4-pulse illumination scheme, the chromatic corrections applied according to this approach do not result in any reduction in the dynamic range which is provided by the display.

Although FIG. 25C has been presented as delivering the maximum common part of the white pixel intensities through the white pulse and “top-up” chromatic corrections during the RGB pulses, it may be energetically preferable to reverse this relationship, instead deriving as much as possible of the white pixel intensity from the RGB pulses, and minimizing the intensity of the white pulse (which does not need to be a balanced white, so long as the overall pixel intensities are balanced). For example, if the white pixel requiring the highest blue correction needs to receive 110% of the maximum blue pulse intensity in order to balance the white color while another requires 105% blue, the white pulse will include intensity corresponding to 10% blue intensity, and the two pixels will be activated during the blue pulse with 100% and 95%, respectively. The same is done for green and for blue. In this way, the light intensity which is anyway being supplied for the RGB color generation is used to the fullest, and the minimum necessary additional illumination is invested in the supplementary white (or mixed color) pulse.

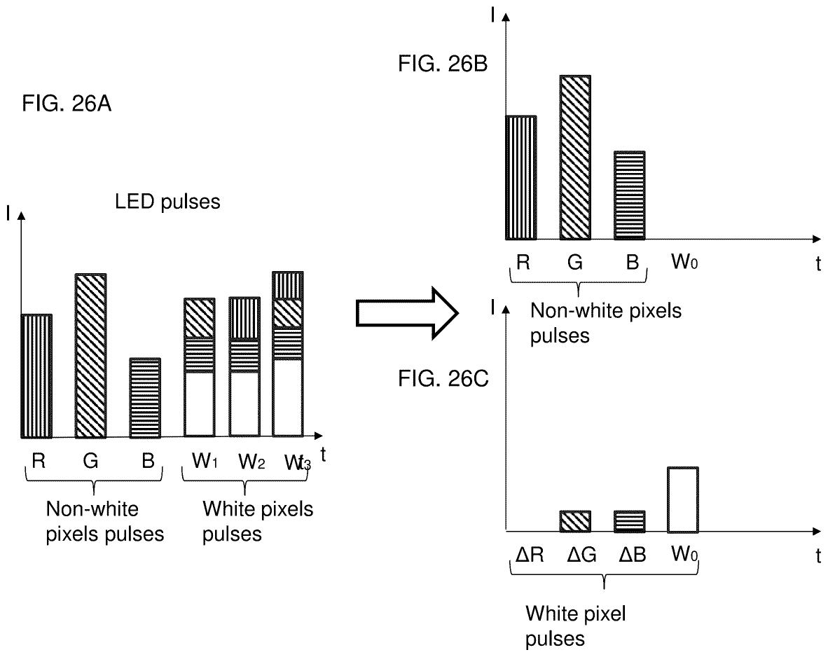

FIGS. 26A-26C illustrate the same restructuring of the frame illumination sequence in the case of FIG. 19A, where the RGB light sources are supplemented with a white source, which could be a broad-spectrum white source as discussed above with reference to FIG. 15B.

Although the embodiments described thus far have provided as examples implementing the white light source as a white LED and implementing of the primary color light sources as a set of LEDs or lasers, other implementations of white or colored light source may also be suitable for use with compact optical arrangements that are part of compact optical display systems. In addition, although the embodiments described thus far have been described within the context of compact optical arrangements for use in compact optical display systems (e.g., NED, HUD), for example as part of AR or VR applications, embodiments of the methods and systems described herein are also applicable for use in non-compact displays, such as displays that utilize larger projector arrangements for projecting images onto larger surfaces or displays. In such embodiments, the white light source can be implemented as any suitable type of light source including a fluorescent source, or any other type of source that is suitable for use with larger displays. In addition, in such embodiments the primary color light sources can be implemented as any suitable type of light source including LED, laser, fluorescent, or any other type of source that is suitable for use with larger displays.

Although the above description has emphasized embodiments in which the illumination scheme is modified by adding additional white illumination or an additional white pulse, certain implementations of a system and method of the present invention may employ generally conventional illumination schemes with only RGB illumination and in a manner generic to different image generation technology (such as SLM or scanning laser image generation). By mapping the chromatic aberrations introduced by the LOE arrangement and its various coatings as observed at the EMB, and preferably at multiple locations across the EMB, the controller and the corresponding method perform per-pixel digital white balance correction, either selectively on white pixels (as broadly defined above), or on all pixels, by adjusting the RGB values according to the chromatic distortion of the corresponding pixel as viewed from the current viewing position (or an average viewing position). Where the desired chromatic correction would require more than 100% of the nominal maximum intensity of a certain light source, the effective intensity of that light source is preferably increased beyond the nominal maximum, such as by increasing the pulse duration or light source luminant output, and the corresponding RGB values for all pixels not requiring the increased intensity are correspondingly reduced. Alternatively, if the maximum source intensity for one of the sources has being reached, the chromatic correction may be facilitated by decreasing the intensity of other sources used.

The control electronics of the image projector include at least one controller, which can be any processing device that includes at least one computerized processor coupled to a storage medium, such as a memory or the like, that is capable of executing computer instructions. The computerized processor of such processing devices, including the computerized processor of the processing subsystem can be implemented as any number of computer processors including, but not limited to, a controller, a microcontroller, an FPGA, a microprocessor, an ASIC, a DSP, and a state machine. The aforementioned processor or processors include, or may be in communication with, one or more non-transitory computer readable media, which stores program code or instruction sets that, when executed by the processor, cause the processor to perform actions.

The non-transitory computer readable (storage) medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

The above-described embodiments include processes and portions thereof can be performed by software, hardware, and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

Although the invention has been described in conjunction with specific embodiments thereof, it is evident that many alternatives, modifications, and variations will be apparent to those skilled in the art. Accordingly, it is intended to embrace all such alternatives, modifications and variations that fall within the scope of the appended claims.

1.-13. (canceled)

14. A display for presenting an image to an eye of a user, the display comprising:
(a) a lightguide optical element (LOE) having a pair of mutually parallel major surfaces for supporting propagation of light corresponding to an image by internal reflection at said major surfaces, said LOE including a set of mutually parallel partially reflecting coupling-out surfaces, internal to said LOE and angled obliquely to said major surfaces, for coupling out the light corresponding to the image towards the eye of the user; and
(b) an image projector optically coupled to said LOE for introducing light corresponding to the image into said LOE so as to propagate within said LOE, said image projector including light sources of at least three distinct spectral properties including a red light source, a green light source and a blue light source, and a controller configured to actuate said image projector to generate the light corresponding to the image,
wherein said controller is configured to operate in at least a first mode in which said controller:
(i) receives pixel image data corresponding to an image to be displayed;
(ii) identifies within the pixel data a subset of pixels that are set to a uniform white;
(iii) generates modified pixel data in which data for at least the subset of pixels are modified to correct for chromatic aberration introduced by said LOE; and
(iv) actuates said image projector to generate the image according to the modified pixel data.

15. The display of claim 14, wherein said modified pixel data are generated based on a calibration map of chromatic aberration introduced by said LOE for white light reaching an eye motion box from which the display is to be viewed.

16. The display of claim 14, wherein said modified pixel data are generated as a function of eye position from calibration maps of chromatic aberration introduced by said LOE for white light reaching multiple locations within an eye motion box from which the display is to be viewed.

17. The display of claim 14, wherein said image projector includes a plurality of scanned laser sources.

18. The display of claim 14, wherein said image projector further comprises a spatial light modulator (SLM), and wherein, in said first mode, said controller actuates said light sources to sequentially illuminate said SLM with pulses of light from said red, green and blue light sources and with a pulse of white light.

19. The display of claim 18, wherein the pulse of white light is generated by simultaneous operation of said red, green and blue light sources.

20. The display of claim 18, wherein the pulse of white light is generated at least in part by a white light source.

21. The display of claim 18, wherein two different groups within said subset of pixels are illuminated by two distinct pulses of white light including, respectively, a first white-balance corrective illumination and a second white-balance corrective illumination.

22. The display of claim 18, wherein all of the subset of pixels are illuminated by a common pulse of white light, and wherein white-balance corrective illumination for each of the pixels in the subset of pixels is generated by setting pixels of said SLM to corresponding brightness values during illumination pulses from said red, green and blue illumination sources.
